(19) United States
(12) Patent Application Publication
(10) Pub. No.: US 2022/0177171 A1
(43) Pub. Date: Jun. 9, 2022

(54) APPARATUS AND METHODS RELATING TO FRUIT PACKING

(71) Applicant: KENNEDY TECHNOLOGIES LIMITED, Auckland (NZ)

(72) Inventors: Siobahn Aimee Liza DOUGHTY, Auckland (NZ); Andrei Joseph GAASTRA, Auckland (NZ); Finn Marcus KENNEDY, Auckland (NZ); Hamish Alexander Nigel KENNEDY, Auckland (NZ); Andrew David MCINTYRE, Auckland (NZ); Robert VERCOE, Auckland (NZ); Shelson Philip WHITE, Whangarei (NZ)

(21) Appl. No.: 17/436,285

(22) PCT Filed: Mar. 6, 2020
(86) PCT No.: PCT/IB2020/051931

§ 371 Date: Sep. 3, 2021

(30) Foreign Application Priority Data
Mar. 6, 2019 (NZ) 751370

(51) Int. Cl. B65B 25/04; B65B 35/32; B65B 35/42; B65B 35/44; B65B 35/56; B65G 47/252; B65B 5/10

(52) U.S. Cl. CPC B65B 25/04; B65B 35/32; B65B 35/42; B65B 35/44; B65G 2811/0626; B65G 47/252; B65B 5/101; B65G 2201/0211; B65B 35/56

(57) ABSTRACT

An apparatus and system for aligning and packing rollable items such as prolate or spherical fruit; an apparatus to remove a single tray from a stack of trays and method therefor; a wrapper to wrap a tray in plastic film and method therefor; an apparatus to laterally retain a spherical or prolate fruit and method therefor; and an apparatus for aligning a fruit via series of rollers and/or suction heads and a method therefor.

The present invention relates to an apparatus and system for aligning and packing rollable items. More particularly but not exclusively it relates to apparatus and system to align prolate fruit along their major axis to and/or channel prolate or spherical fruit to be subsequently packed; an apparatus to remove a single tray from a stack of trays and method therefor; a wrapper to wrap a tray in plastic film and method therefor; an apparatus to laterally retain a spherical or prolate fruit and method therefor; and an apparatus for aligning a fruit via series of rollers and/or suction heads and a method therefor.

### BACKGROUND

Some current kiwifruit packing systems require a worker to manually pick up, and place kiwifruit into a pre-formed pocket of a tray. There may be multiple pre-formed pockets in one tray, and in most cases all of the pockets are aligned in the same direction, so that the major axes of all the fruit in one tray are parallel to each other. Manual orientation and placement of kiwifruit into a tray is time consuming. The trays may be lifted and separated manually from a stack of trays. The trays may be wrapped manually in plastic film, and subsequently manually placed into a carton.

For the purposes of this specification, the term “plastic” shall be construed to mean a general term for a wide range of synthetic or semisynthetic polymerization products, and generally consisting of a hydrocarbon-based polymer.

For the purpose of this specification, where method steps are described in sequence, the sequence does not necessarily mean that the steps are to be chronologically ordered in that sequence, unless there is no other logical manner of interpreting the sequence.

### STATEMENTS OF INVENTION

In a first aspect the present invention may be said to consist in an apparatus for presenting generally spherical or prolate like items for off take, the apparatus comprising or including a conveyor, the conveyor comprising; a receiving zone receive said items, a downward sloped alignment zone to at least convey the items down the alignment zone towards an off take zone to allow or cause the off take of the items from the conveyor; wherein the items can advance under gravity in an advancement direction down the sloped alignment zone, from the receiving zone to the off take zone, whilst being supported on a rising support surface or rising support surfaces of the conveyor, that rise in direction up the sloped alignment zone, opposite to the direction of the advancement direction.

In one embodiment, the receiving zone is able to receive prolate, ovoid or the like elongate items in heterogenous alignments to each other, and the alignment zone is configured to align the items to a homogenous alignment with their major axis transverse to the advancement direction, and the off take zone is configured to allow or cause the off take of the items still in said homogenous alignment.

In one embodiment, at least part of the item support surface or surfaces of one, two or all three of the zones has item stream partition features whereby in use separated streams of items present for serial off take of the lowermost or most advanced item of each stream.

In one embodiment, the conveyor is a belt conveyor, roller, or a series of rollers.

In one embodiment, the off take zone is adapted for placement of each item into a pocket of a tray.

In one embodiment, the off take zone is located at or on the rising support surfaces.

In one embodiment, the receiving zone cascades items onto the alignment zone or itself has a rising surface or rising surfaces from which items can advance under gravity, where the rising surface is a belt, walking beam or other conveyor, drum roller, or the like, and the rising surfaces is a plurality of rollers, plural rollers but with static interposed supports, or the like.

In one embodiment, the apparatus comprises a plurality of elongate lanes parallel each other and extending in the advancement direction, the lanes configured to partition a stream or pool of items received at the receiving zone, into lanes of single file items at the alignment zone and/or offtake zone.

In one embodiment, the lane has an exit region where items are at the end of the lane, or are exiting the lane.

In one embodiment, the lane has an exit region at the off take zone, the item is configured to be retained, by a holder, within the lane, the item in the lane constantly rotating about its major axes due to the rising support surface or rising support surfaces.

In one embodiment, the exit region and/or off take zone corresponds and/or is aligned with a pocket of a tray.

In one embodiment, the lane is aligned and/or colinear with a pocket of a tray.

In another aspect the present invention may be said to consist in a method of guiding a spherical, prolate, ovoid or the like rollable item so that it may be fed into a plurality of elongate lanes on a declined slope, the lanes parallel each other and extending in an advancement direction, said method comprising the step of gravity advancing the item in a stream of such items against the rising movement of a surface on which the items are supported.

In another aspect the present invention may be said to consist in a method of aligning a prolate, ovoid or the like item so that it may be fed laterally of its major axis, said method comprising the step of gravity advancing the item in a stream of such items against the rising movement of a surface on which the items are supported.

In one embodiment, item is fruit and/or kiwifruit.

In one embodiment, the surface is of a conveyor.

In one embodiment, the conveyor is a belt conveyor, roller, or a series of rollers.

A method as described above, where there is the step of taking the fed fruit or receiving the fed fruit from the surface for placement in that alignment into a pocket of a fruit tray.

Wherein any of the below embodiments relate to any of the above inventions.

In one embodiment, the slope of the sloped conveyor at one, two, or three of the zones is between 5 degrees and 30 degrees from horizontal.

In one embodiment, the slope of the sloped conveyor at one, two, or three of the zones is 18 degrees.

In one embodiment, the item is produce, such as fruit.

In one embodiment, the major axis travels between the stem (stalk, or calyx) and the tip (blossom end, stamen, or apex) of the fruit.

In one embodiment, the conveyor is formed from a belt, chain, endless loop, rollers or walking beam.

In one embodiment, the conveyor comprises a higher end region towards where an item is configured to be received by the conveyor, and a lower end region towards where an item is able to be removed from the conveyor.

In one embodiment, at the lower end region the apparatus comprises one or more dividers to divide the lower end region into two or more lanes.

In one embodiment, the lower end region of the conveyor is also sloped.

In one embodiment, the dividers are upright walls upstanding above the one or more supporting surfaces.

In one embodiment, the lanes have a width of less than one and a half times the width (along the major axis) of a single item.

In one embodiment, the lanes have a width of approximately the same width of a single item.

In one embodiment, the lanes have a length of approximately one half the length of the sloped conveyor.

In one embodiment, the lanes have a length of approximately 300 mm.

In one embodiment, a lane comprises an entry region configured for an item to enter into said lane, and an exit region, opposite the entry region, configured for an item to be held at and subsequently removed from said lane.

In a further aspect the present invention may be said to consist in a fruit packing system configured to receive fruit, the system comprising

an apparatus as described above, configured to align items along their major axis, and convey said items into single file lanes, each lane comprising an exit region configured for a lowermost item to be retained at and an off take zone for the item to be subsequently removed from.

In one embodiment, the system comprises a holder; to retain said lowermost item at the exit region; and hence support any supported fruit in the single file above the lowermost item.

In one embodiment, the holder is configured to remove the lowermost fruit from the off take zone, to hold said fruit in a presentable condition, and/or where the presentable condition is a stationary position.

In one embodiment, the off take zone is at the exit region.

In one embodiment, the off take zone is adjacent and/or overlapping the exit region.

In one embodiment, the fruit is rotating whilst in the stationary position.

In one embodiment, the system comprises a transfer device to remove an item from one or more exit regions and/or off take zones, or from the holder.

In one embodiment, the system receives and aligns fruit, and the transfer device is configured to transfer fruit from a transfer region to a pocket of a tray.

In one embodiment, the transfer region is located at the conveyor, aligner or holder.

In one embodiment, the transfer region is located at exit region, off take zone or is separate.

In one embodiment, the transfer region corresponds and/or is aligned with a pocket of a tray.

In one embodiment, the transfer is aligned and/or colinear with a pocket of a tray.

In one embodiment, the belt at the exit region, holder and dividers are configured to allow fruit to be serially removed from the exit region.

In one embodiment, the holder comprises one horizontal elongate holding member to retain an item at the off take zone.

In one embodiment, the holder comprises at least two horizontal elongate holding members, a first holding member and a second holding member, perpendicular to the conveying direction, the first holding member and second holding member defining a gap therebetween to support an item removed from the exit region.

In one embodiment, the holder comprises a central holder pivot point which the two holding members are configured to rotate about, said rotation axis of the holder pivot point parallel with the elongate axis of the holding members.

In one embodiment, the holding members are cylindrical and/or soft.

In one embodiment, the holder has; a retaining position where the first holding member is configured to retain an item at said exit region; and a holding position, where the holding members have been rotated or shifted from the retaining position, and the holding members are configured to fully supported an item intermediate the first holding member and second holding member.

In one embodiment, the holding members are configured to rotate about their elongate axis.

In one embodiment, the holding members are configured to be driven so as to rotate about their elongate axis.

In one embodiment, the holding members are configured to rotate in both directions.

In one embodiment, the holder can maintain both the retaining position and the second holding position simultaneously.

In one embodiment, the holder comprises a holder divider configured to retain fruit laterally on the holder.

In one embodiment, the holder divider is a vee shaped device, that is flexible, and is configured to retain a fruit centrally within the valley of the vee shape.

In one embodiment, the transfer device is configured to transfer fruit from the exit region, to said pocket.

In one embodiment, the transfer device is configured to transfer fruit from the holder at a holding position, to said pocket.

In one embodiment, the transfer device comprises a vacuum cup mechanism, or a gripping mechanism.

In one embodiment, the system comprises a tray device to deposit a tray at or near the holder.

In one embodiment, the tray device comprises a vacuum pad to engage with an uppermost tray from a stack of trays.

In one embodiment, the vacuum pad is conformable to conform to the shape of a tray.

In one embodiment, the vacuum pad is configured to actuate back and forth to release an uppermost tray from said stack of trays.

In one embodiment, the vacuum pad comprises lateral wings to actuate portions of an uppermost tray.

In one embodiment, the system comprises a wrapper configured to wrap a tray containing fruit, in a thin plastic film, of a generally square or rectangular shape, the tray having a top, bottom opposite the top, sides, and ends opposite and perpendicular to the sides.

In one embodiment, the wrapper comprises a film driver configured to push a portion of said film, which is hanging vertically, under the side of a tray containing fruit.

In one embodiment, the film driver is configured to support said tray containing fruit, with said film intermediate the driver and the bottom of the tray.

In one embodiment, the film, intermediate the film driver and tray, is wrapped about the tray sides, and over at least a portion of the tray top.

In one embodiment, the wrapper comprises a film tucker, configured to tuck the film under the ends of the tray, intermediate the portion of said film and film driver.

In one embodiment, the film tucker comprises a two pairs of bars, a holding bar and a tucking bar, located at each end of a tray when present, the holding bars located under the wrapped tray when present, the tucking bars located above the wrapped tray when present; the tucking bars configured to actuate downwards below the holding bars, and inwards towards each other under the tray, so configured to wrap film about the ends and under at least a portion of the tray bottom

In one embodiment, the wrapper comprises a depositor, configured to deposit, to in operation deposit a wrapped tray into an awaiting carton.

In a further aspect the present invention may be said to consist in an apparatus for presenting prolate, ovoid or the like elongate items for off take, the apparatus comprising or including a receiving zone of a surface or surfaces to receive said items in heterogenous alignments, an alignment zone to align the items to a homogenous alignment, and an off take zone to allow or cause the off take of the items still in said homogenous alignment; wherein the items can advance under gravity from the receiving zone to the off take zone, through at least the alignment zone, whilst being supported on a rising support surface or rising support surfaces, whereat the items will assume said homogenous alignment with their major axis transverse to the advancement direction.

In a further aspect the present invention may be said to consist in an apparatus to feed prolate, ovoid or the like items to trays and each item into a tray pocket requiring a particular alignment of the item, a zone to align each item as each moves down an incline under gravity, that zone being characterised in that its item support surface moves, or it has item support surfaces that move, upwardly as each item moves downwardly.

In a further aspect the present invention may be said to consist in an apparatus for aligning one or more prolate items along their major axis, the device comprising a sloped conveyor, formed from one or more support surfaces, that are configured to move in a rolling direction up the slope, the conveyor configured to convey said items in a conveying direction opposite to the rolling direction due to the sloped conveyor declining in the conveying direction allowing the items to be conveyed under gravity.

In another aspect the present invention may be said to consist in a method of presenting a side of an item to a first direction by rotating the item about two axes, the method comprising the steps of
a. rotating the item about a first axis to a first orientation, by at least two parallel rollers that support said item, the rollers rotating about roller axes parallel to the first axis,
b. separating the item in the first orientation from the two rollers by a transfer device,
c. rotating the item to a second orientation, by rotating the transfer device, about a second axis not parallel (preferably perpendicular) to the first axis, and
d. re-supporting the item on the two rollers in the second orientation.

In one embodiment, the method comprises the step of, when required to achieve presentation of the side of the item to a first direction, rotating the item about the first axis to a third orientation by the rotation of the rollers.

In one embodiment, one or more of the rollers are rotatably driven.

In one embodiment, the method comprises the step of removing the item from the rollers by one or more selected from a transfer device, and actuating the rollers so the item falls off the rollers.

In one embodiment, the method comprises the step of the item being received by a second set of parallel rollers that are configured to one or both of a) actuate to cause the item to fall off the rollers and b) rotate the item about a horizontal axis to a third orientation by the rotation of the second set of rollers.

In one embodiment, the separating of the item from the rollers is achieved by lifting the item from the rollers, and/or the re-supporting of the item on the rollers is achieved by placing the item onto the rollers.

In one embodiment, the direction of movement of lifting the item off the two rollers and/or placing the item onto the two rollers, is collinear with the second axis.

In one embodiment, the method includes the step of providing optical means to determine in what orientation the item is in, and/or should be in.

In one embodiment, the method includes the step of determining an optimum side of the item.

In one embodiment, the method includes the step of orientating the item so that a side, and/or the optimum side is orientated in a first direction.

In one embodiment, the first direction is upwards.

In one embodiment, the method includes the step of transferring the item from the rollers, into a tray, by the transfer device, with the side presenting in the first direction.

In one embodiment, the transfer device is comprises one of a suction cup or gripping mechanism.

In one embodiment, the item is spherical, prolate, ovoid, and/or of a rollable, shaped item, and/or the item is a fruit.

In one embodiment, the rollers can support multiple items laterally adjacent each other.

In one embodiment, there are multiple transfer devices to complement the multiple items.

In one embodiment, there are multiple transfer devices for relating to one item, each transfer device with a different function.

In one embodiment, the apparatus comprises one or more transfer devices configured for one or more of the following:
transfer the item from the conveyor onto the first set of rollers
separate the item from the first set off rollers and/or second set of rollers
rotate the item when separated from first set off rollers and/or second set of rollers
transfer the item to the second set of rollers
transfer the item from the first set off rollers and/or second set of rollers to a carton or other location.

In one embodiment, the transfer device is or comprises one of a suction cup or a gripping mechanism.

In another aspect the present invention may be said to consist in an apparatus for presenting a side of an item to a first direction, the apparatus comprising
a. at least a pair of rollers, of which at least one is rotationally driven, having parallel rotational axes, configured to support and rotate the item about a first axis parallel with the roller rotational axes,
b. one or more transfer devices configured to,
   i. removable couple to the item;
   ii. once coupled, separate and re-support the item from and to the rollers; and
   iii. rotate about a second axis not parallel (preferably perpendicular) to the first axis, so in operation said coupled item can be rotated respectively when separated from the rollers.

In one embodiment, the rollers can support multiple items laterally adjacent each other.

In one embodiment, there are multiple suction cups to complement the multiple items.

In one embodiment, the apparatus comprises a second set of parallel rollers that are configured receive an item and also configured to one or both of a) actuate to cause the item to fall off the second set of rollers and b) rotate the item about a horizontal axis to a third orientation by the rotation of the second set of rollers.

In one embodiment, one or more of the rollers of the second set of rollers are rotatably driven.

In one embodiment, the first and second set of rollers can support multiple items laterally adjacent each other.

In one embodiment, there are one or more transfer devices configured to one or more of the following:
a. transfer the item from the conveyor onto the first set of rollers
b. separate the item from the first set off rollers and/or second set of rollers
c. rotate the item when separated from first set off rollers and/or second set of rollers
d. transfer the item to the second set of rollers
e. transfer the item from the first set off rollers and/or second set of rollers to another location.

In one embodiment, the transfer device is or comprises one of a suction cup and a gripping mechanism.

In another aspect the present invention may be said to consist in an apparatus for laterally retaining generally spherical or prolate like items, the apparatus comprising
a. a conveyor to convey items to an off take zone,
b. a holder to receive items from or partially from the off take zone, the holder and conveyor together, or the holder alone, configured to move the item to and/or support the item at, a transfer region,
c. at least one holder divider located at the transfer region, the holder dividers configured to retain the item laterally with respect to the elongate member.

In one embodiment, the holder divider is vee shaped.

In one embodiment, the vee shaped holder divider has flexible lateral walls that form the vee shape.

In one embodiment, the holder comprises one or more holding members that are elongate cylinders, and/or wherein one or more of the holding members are configured to rotate about their elongate axis.

In one embodiment, the vee shaped holder divider is located intermediate the conveyor and holder, and/or at the vee shaped holder divider is located at the transfer region.

In one embodiment, the vee shaped holder divider is located intermediate the two holding members that comprise the holder

In one embodiment, the vee shaped holder divider is configured to orientate items about their elongate axis, if present, to be parallel the elongate axis of the holding member(s).

In another aspect the present invention may be said to consist in a method of laterally retaining generally spherical or prolate like items, the method comprising the steps of
a. providing the apparatus for presenting generally spherical or prolate like items for off take as described above,
b. receiving an item on the conveyor,
c. conveying the item to an off take zone via the conveyor,
d. receiving the item at a transfer region from the off take zone, where the item is at least partially supported by the holder, and
e. retaining the item with the at least one holder divider at the transfer region laterally relative to the holder.

In one embodiment, holder comprises one or more holding members that are elongate cylinders.

In one embodiment, the holder divider is vee shaped.

In one embodiment, the holder divider has flexible lateral walls that form the vee shape.

In one embodiment, the step of rotating one or more selected from; the holding member, the holding members, and the conveyor, whilst the item is supported at least partially by the holder and retained by the holding member.

In one embodiment, the holding member is vee shaped and has lateral walls in contact with the item so the item tends to orientate its elongate axis to be parallel the elongate axis of the holding member, when the item is also rotated via one or more selected from the holding member, the holding members, and the conveyor.

In one embodiment, the method comprises the step of presenting the item for transfer from the transfer region.

In another aspect the present invention may be said to consist in a wrapper configured to wrap a tray containing items such as fruit, in a thin plastic film, of a generally square or rectangular shape, the tray having a tray top, tray bottom opposite the tray top, tray sides, and tray ends opposite and perpendicular to the tray sides, the wrapper comprising,
a film driver configured to either
   a) push a portion of said film, which is hanging to the side of a tray, under the tray bottom, or
   b) receive a tray and a portion of said film which is under the tray bottom;
   wherein the film driver comprises a support surface to support said tray, with said film intermediate the support surface and the tray bottom,
a film tucker comprising a pair of tucking bars located at each tray end when present, the tucking bars located at or towards the tray top when present; the tucking bars configured to actuate downwards below the tray bottom, and inwards towards each other under the tray bottom, the film tucker so configured to wrap a portion said film about the tray ends and under at least a portion of the tray bottom.

In one embodiment, the tucking bars are configured to actuate under the film driver.

In one embodiment, the film tucker comprises a pair of holding bars, where the holding bars are located under the tray bottom when present, and are configured to move upwards above the tray bottom.

In one embodiment, the holding bars are located more towards each other than the tucking bars.

In one embodiment, the film, intermediate the film driver and tray, is wrapped about the tray sides, and over at least a portion of the tray top.

In one embodiment, the film tucker is configured to tuck the film under the ends of the tray, intermediate the portion of said film and film driver.

In one embodiment, the wrapper comprises an elongate substantially horizontal hollow bar defining an inner conduit, the bar comprising one or more holes along its length, and further configured to translate up and down.

In one embodiment, the bar is configured to have low-pressure drawn through the inner conduit so as to suck adjacent film into or onto the holes.

In one embodiment, the bar is configured to rotate.

In one embodiment, one or more of the film driver, tucking bars, holding bars and hollow bar are servo actuated.

In one embodiment, the film is drawn from a roll of film.

In another aspect the present invention may be said to consist in an apparatus to uplift a single tray from a mutually nested stack of trays, the apparatus comprising

a suction head deployable to both uplift, and translocate from any of a stack of such trays that remain(s), a topmost tray, and

at least one input member to co-act with the suction head to de-nest such a topmost tray from its adjacent tray, if any.

In one embodiment, the at least one input member is at least a pair of wing members carried with the suction head.

In one embodiment, the wing members are configured to actuate towards and away from the plane of a tray.

In one embodiment, the input member(s) is(are) actuable to vibrate and/or oscillate.

In one embodiment, the input member(s) bears (bear) on said topmost tray alone.

In one embodiment, the input member(s) bears (bear) on such an adjacent tray.

In one embodiment, the translocation is to a conveyor at which the suction head releases the tray.

In one embodiment, the translocation is to a tray filling station at which the suction head releases the tray.

In one embodiment, the suction head and/or input members are conformable to conform to the shape of a tray.

In one embodiment, the input member(s) are actuated responsive to a sensor input.

In one embodiment, the sensor is a light level detection sensor. In one embodiment, the tray is a PLIX tray.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “spherical” as used in this specification and claims means generally shaped like a sphere or ball. Likewise the term rollable means any item that will tend to roll when put on a slope of a great enough inclination, or when supported by rollers that are rotated. Such items that are rollable for example are apples, kiwifruit, rugby balls, eggs, polygonal sided footballs etc. Other items that are not truly spherical, such as a spherical hexagon, geodesic polyhedron, spherical polyhedron etc. are included in the term spherical and prolate spherical.

The term “comprising” as used in this specification and claims means “consisting at least in part of”. When interpreting statements in this specification and claims which include that term, the features, prefaced by that term in each statement, all need to be present but other features can also be present. Related terms such as “comprise” and “comprised” are to be interpreted in the same manner.

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.)

### BRIEF DESCRIPTION OF THE FIGURES

The invention will now be described by way of example only and with reference to the drawings in which:

FIG. 1A-G: shows a top schematic view of a conveyer with two items trying to enter the entry region of a lane.

FIG. 2A-E: shows a perspective view of a conveyor with two items orientating themselves along their major axis.

FIG. 3: shows a top view of a plurality of lanes, highlighting two items stabilising each other, and one item being unstable.

FIG. 4A: shows a top view of an aligner with a pool of accumulated items above the entry regions of full lanes.

FIG. 4B: shows a top view of an aligner with accumulated items above the entry regions of some full, and some partially full lanes.

FIG. 4C: shows an aligner spreading unevenly loaded fruit.

FIG. 5: shows an aligner with an ideal minimum load of fruit before progression with packing. I.e. there is fruit ready to pack with one behind to stabilise its rotation.

FIG. 6: shows a perspective view of conveyor where the support surfaces are rollers.

FIG. 7: shows a side view of a conveyor with different sloped sections.

FIG. 8: shows a perspective view of a conveyor, with dividers, and associated vacuum cups of a transfer device, with parts removed for clarity.

FIG. 9A: shows a cross section side view of the off take zone and holder with the dividers hidden, with a retained item and two serially adjacent supported items, with the retained item is beginning to be removed from the exit region.

FIG. 9B-D: shows the process continuing on from FIG. 9A, with an item being removed from the exit region.

FIG. 9E-G: shows the process continuing on from FIG. 9D, with an item being held at held position, ready for removal via a transfer device, or removal via the holder continuing to rotate.

FIG. 9H-K: shows the process continuing on from FIG. 9G, with an item being rotated off the holder from the held position.

FIG. 10A-E: shows a cross section side view of the off take zone and holder with the dividers hidden, with a retained item and two serially adjacent supported items, with the held item being to be reinserted into the retained position on the conveyor at the exit region.

FIG. 11A-E: shows a cross section side view of an alternative embodiment holder, and the process of removing an item from a retained position to a held position.

FIG. 12A-E: shows a schematic side view of a transfer device, and the process of picking up and placing down an item.

FIG. 13A-I: shows a front view of a tray device and stack of trays with an uppermost tray, and the process involved in picking up the uppermost tray from the stack of trays. Where FIG. 13B shows the vacuum pad making contact with the uppermost tray. FIG. 13C-I shows the wings of the vacuum pad oscillating to prevent more than one tray being removed.

FIG. 14A-F: shows a schematic side view of a tray and wrapping device, and the associated process to wrap film around the tray front, bottom and end.

FIG. 15A-C: shows an end cross section view of a wrapper, and film tucker, tucking film about the tray sides and under the tray bottom.

FIG. 16A-C: shows a side view of a tray and depositor, and the associated process to deposit a tray in a carton.

FIG. 17: shows a schematic side view of a system.

FIG. 18: shows a perspective view of two items held by two examples of a holder divider.

FIG. 19A: shows a schematic side view of an alternative item aligner, showing an item received onto rollers.

FIG. 19B: shows a schematic side view of the alternative item aligner, showing the rollers rotating an item to a first orientation.

FIG. 19C: shows a schematic side view of the alternative item aligner, showing the item having been rotated into a first orientation, being coupled to a suction cup.

FIG. 19D: shows a schematic side view of the alternative item aligner, showing the item having been lifted off the rollers by a suction cup, being rotated about a second axis to a second orientation by the suction cup.

FIG. 19E: shows a schematic side view of the alternative item aligner, showing the item having been rotated to a second orientation, being placed onto the rollers by the suction cup.

FIG. 19F: shows a schematic side view of the alternative item aligner, showing the suction cup decoupling from the item.

FIG. 19G: shows a schematic side view of the alternative item aligner, showing the item being rotated to a second or third orientation by the rollers, with the optimum region being presented in the preferred direction.

FIG. 20: shows a schematic side view of a further alternative item aligner, showing the use of two sets of rollers and two transfer devices.

FIG. 21: shows a schematic side view of an item aligner with a holder divider intermediate the conveyor and a holding member.

FIG. 22: shows a schematic side view of FIG. 22, where the holding member has been actuated to reject the item

FIG. 23: shows a schematic side view of an alternative item aligner where the conveyor is not angled downwards towards the transfer region.

FIG. 24: shows a schematic side view of an item aligner where there are two holding members forming the holder at the transfer region with a holder divider intermediate.

FIG. 25: shows a top perspective view of a tray device.

FIG. 26: shows a side view of a tray device, highlighting the actuating mechanism and wings.

FIG. 27: shows a bottom perspective of a tray device.

FIG. 28: shows a side cross section view of a process of a hollow bar drawing down film.

### DETAILED DESCRIPTION

With reference to the above drawings, in which similar features are generally indicated by similar numerals, an item aligner and packing system according to a first aspect of the invention is generally indicated by the numeral 1000.

The item aligner can achieve at least two functions; 1) help channel items into lanes, and 2) help align prolate items about their major axis.

The item aligner is generally good at aligning items about their major axis that are of a prolate spheroid type shape, such as rugby ball shaped. In particular such items are generally produce. The produce may be eggs, kiwi fruit, lemons, limes, feijoas, even chocolate eggs etc. Such items, for convenience, may be referred to as to fruit in the specification.

The item aligner is generally good at channelling items that are rollable, into lanes, whilst reducing damage to the items. Such rollable item may be the prolate spheroid items as described above, as well as spheroid shaped items such as some apples, tomatoes, plums etc. These fruit may in some instances have a major axis that will also able to be aligned however.

In one embodiment now described, there is provided an item packing system 1000 comprising one or more of the follow apparatus and associated processes:

Empty fruit trays 20 typically arrive in a stack 27, where multiple fruit trays 20 nest within and on top of one another. The trays need to be separated so one tray can be removed from the stack 27 and taken to a location where fruit can be placed on the tray.

A known tray in the industry is made by ALTO PACKAGING and is called the PLIX® POCKETPACK. These trays have individual pockets 28 for individual fruit. The pockets 28 are all typically aligned in the same direction, with some exceptions. A tray device 200 removes an uppermost tray 26 from a stack of trays 27, and delivers said to a preferred location, where it can be filled with fruit 10.

Before placement into a tray 20, fruit 10 is channelled single file into lanes, ready for removal by a transfer device. If the fruit is not spherical, and are prolate, it may be desired that the fruit is aligned in a homogeneous direction ready for removal by a transfer device.

In one embodiment, fruit is aligned according to the alignment of the pockets 28, so no further rotation of the fruit is necessary. A fruit aligner is utilised to align each fruit before placement. Briefly, the fruit aligner utilises a sloped conveyor 110 on which the fruit can travel downwards towards said tray 20 to be placed in. The conveyor 110 comprises one or more supporting surfaces that travel in a rolling direction 4 up the slope (i.e. rising surfaces) and in the opposite direction to the conveying direction 3 of fruit travel. The upwards rising movement of the supporting surface(s) allows both channelling items into lanes, and optionally aligning prolate items about their major axis.

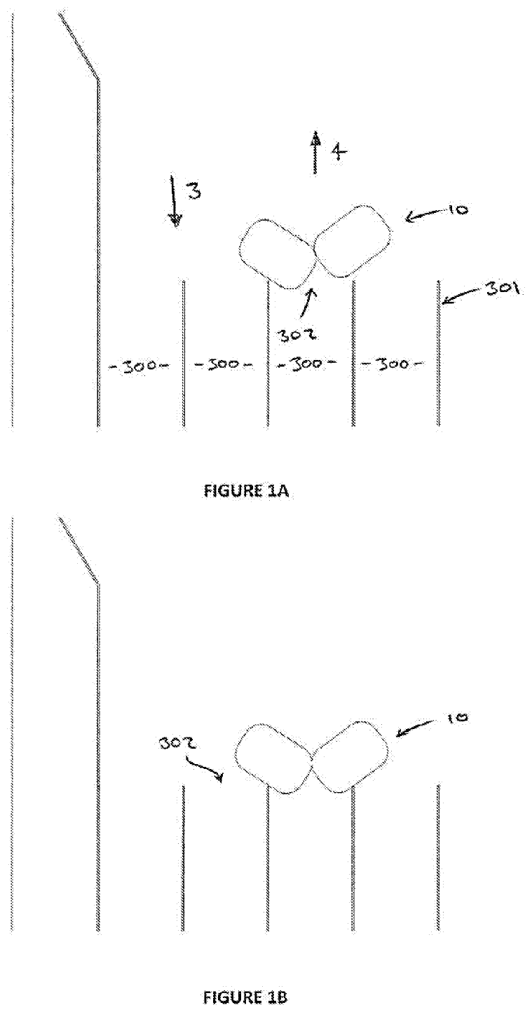

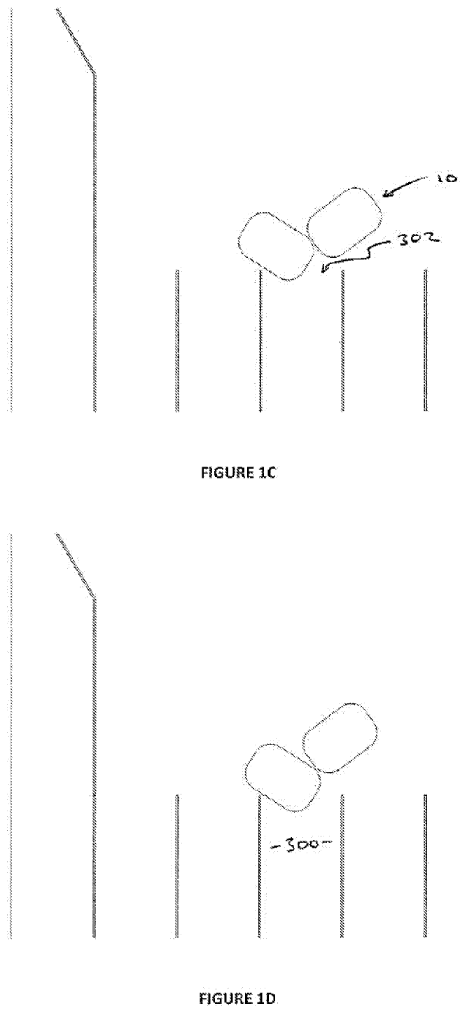

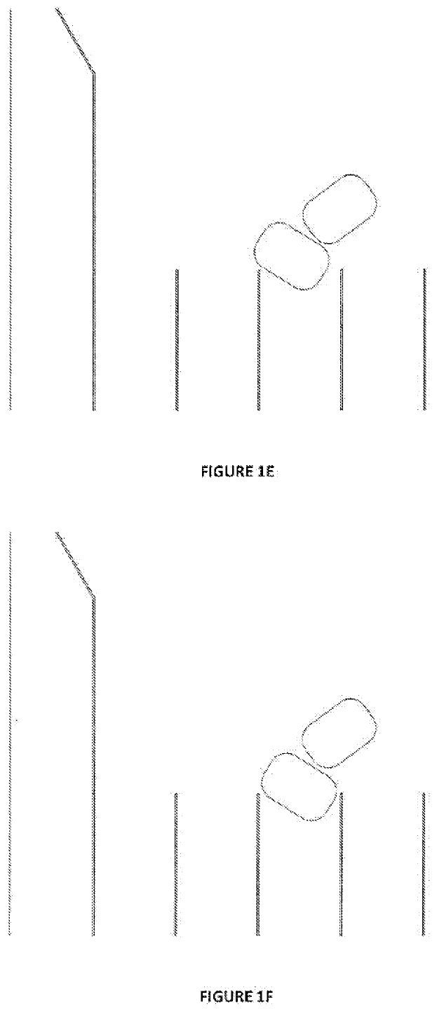

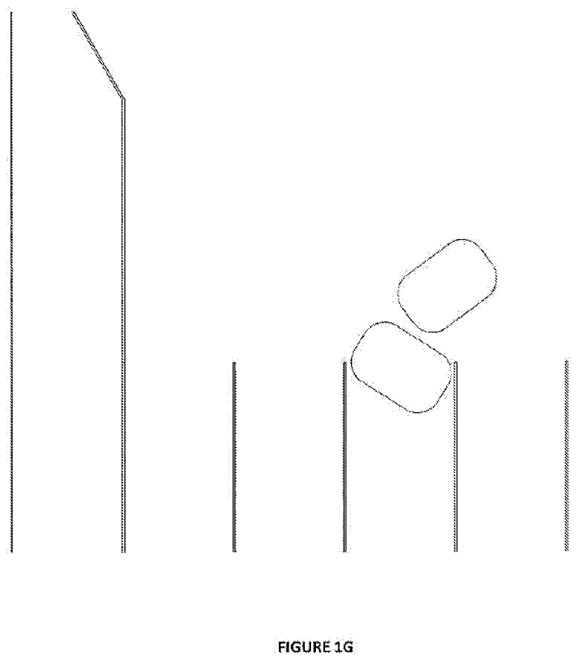

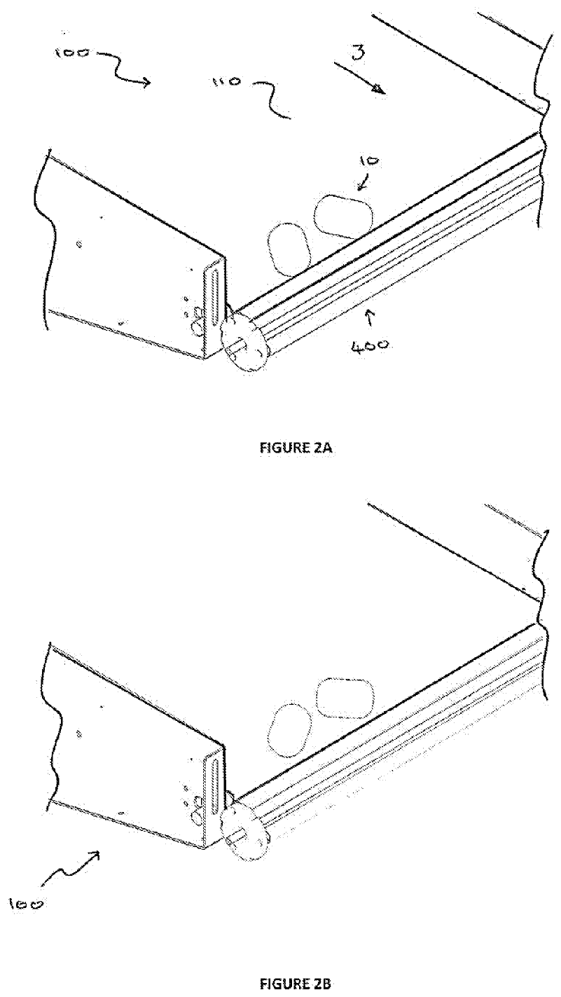

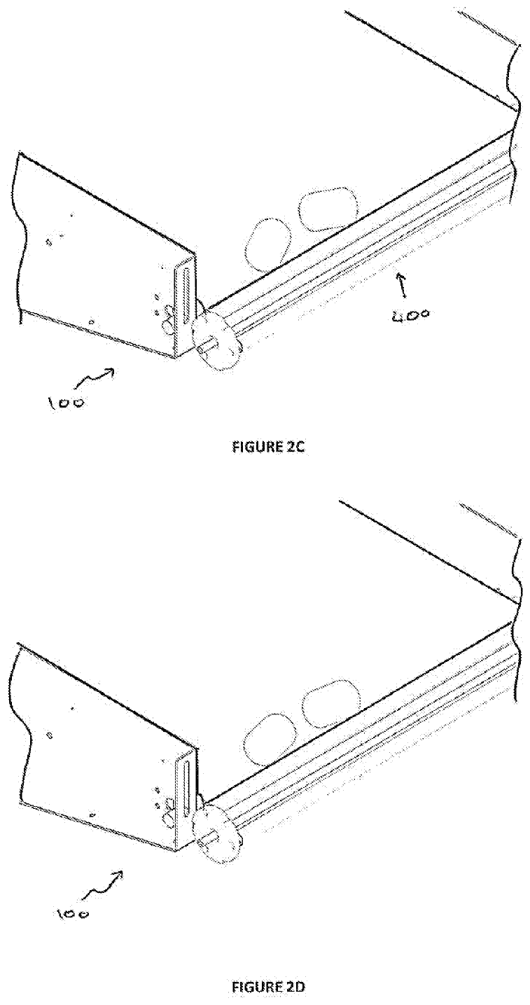

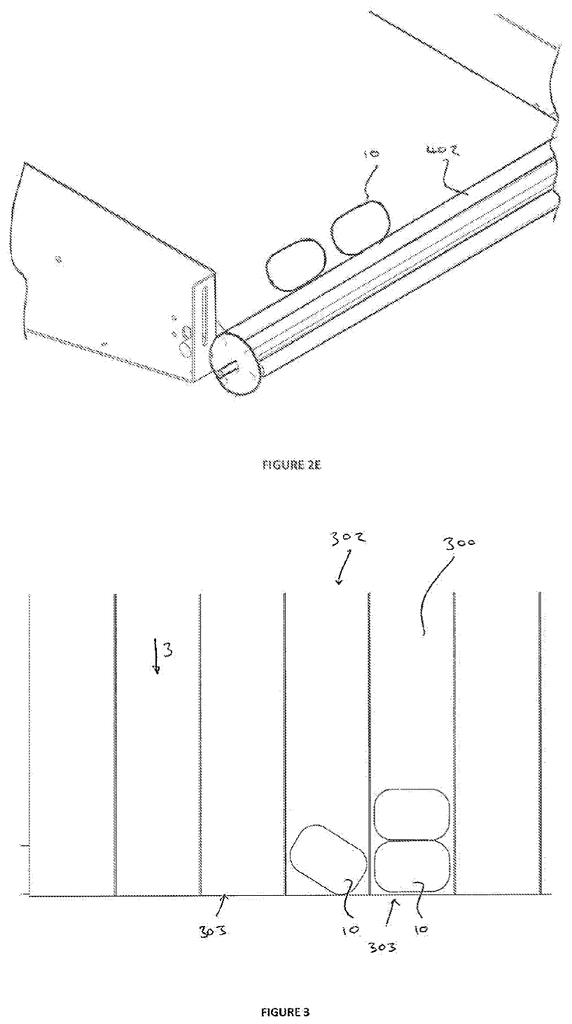

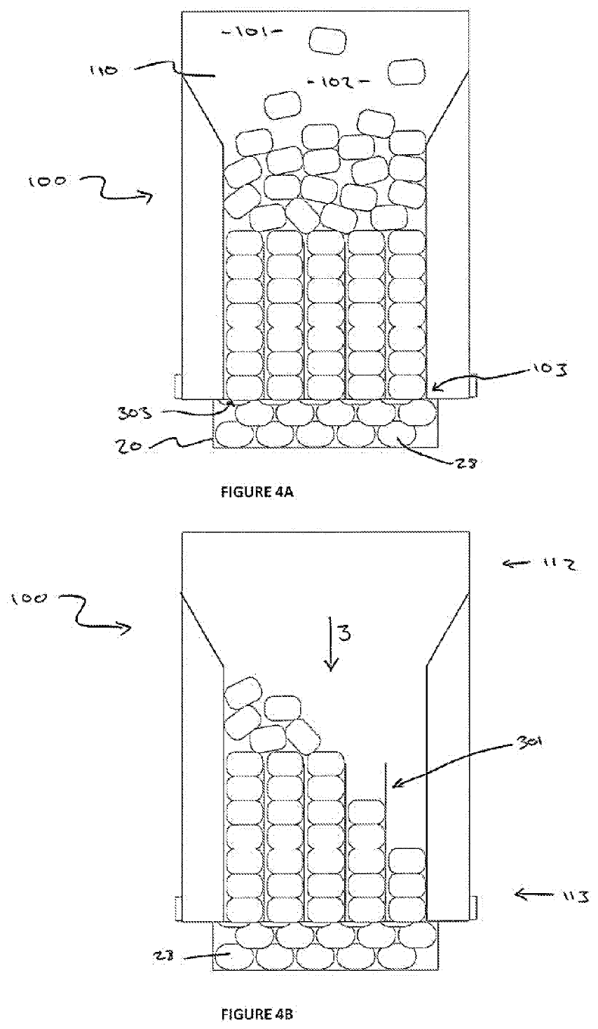

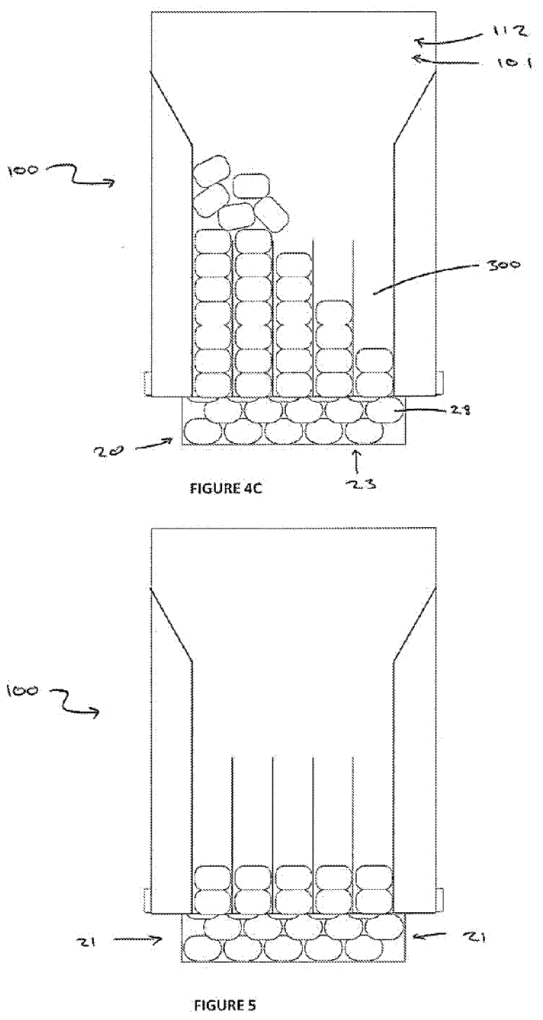

It is desired that the fruit aligner (that can both align, as well as channel) is configured to gently channel the fruit into lanes, with low impact on the fruit so as to reduce bruising, damage, etc. In particular, damage can occur to items when they bridge across the dividers that divide two lanes. The fruit aligner reduces damage in this instance, due to the upwards rising surfaces not driving the items into dividers. The fruit aligner also reduces damage to items, when two or more items are being channelled into the same lane (as shown in FIG. 1). The upwards rising surface helps prevent the items from being driven and compressed into each other and into the lane dividers, instead, the items tend to roll and align until one item enters the lane.

The fruit are preferably divided into one or more lanes. The one or more lanes 300 are formed by one or more dividers. Each lane 300 guiding the fruit to a particular pocket present at the end of a lane, at a particular time—or at least to present fruit a holder or transfer device, that can subsequently transfer the fruit to a pocket. The lanes 300 are preferably arranged at the lower region of the conveyor.

At the end of the surface, there is an off take zone 103. The off take zone may corresponds to an exit region 303 of the lanes 300, or may be adjacent of overlapping with the exit region. At the exit region 303 fruit are retained in place on the conveyor 110 until they are removed. The fruit may be removed from the off take zone 103 by a holder mechanism. Fruit are then removed from the holder mechanism via a transfer device 500 to be placed into a tray, or in some embodiments, the holder transfers the fruit directly to tray pockets, without the need for a separate transfer device.

The tray 20 may then be wrapped by a wrapper device 600 in a thin plastic film 602. The wrapped tray 20 may then be deposited by a depositor 700 into a carton 701. The carton containing the wrapped tray 20 full of fruit, is then ready for shipping or any subsequent steps such as applying or closing a lid on the tray or carton.

Fruit is received at a first receiving region 101 onto an aligner 100 from a conveyor belt (not shown) or another source. The other source may be a machine or worker depositing fruit from a carton or other vessel onto the aligner 100.

The aligner comprises a conveyor 110 that slopes downwards in the direction of the travel 3 of the fruit 10. The fruit advances/conveys downwards down the conveyor influenced by gravity, towards the off take zone 103.

The conveyor comprises one or more support surfaces 111. The one or more support surfaces 111 are configured to support and rotate the fruit 10. The one or more support surfaces 111 are configured to move in a direction 4 up the decline. For example if the surface 111 is a conveyor belt, the conveyor belt will be sloped downwards but will be moving in a direction up the decline. I.e. the surface 111 travels backwards to the direction of fruit travel 3.

The one or more supporting surfaces 111 move up the slope, against the flow (direction of advancement 3) of fruit 10. The fruit tend to roll down the conveyor 110 due to gravity. The fruit tends to align itself along its major axis 17. Where the major axis 17 is defined as the axis of rotation of the prolate spheroid shaped fruit. This axis 17, on most fruit, travels between the stem/stalk 18 of a fruit, to the tip/blossom/stamen end 19 of the fruit 10.

Prolate spheroid type objects when rolled will want to move to a stable state. A stable state for a prolate spheroid shaped object is when its major axis 17 is collinear with the axis of rotation. This is why the conveyor 110 comprises support surfaces 111 that drive the fruit to rotate backwards up the incline. The surface(s) 111 are declined in a direction of fruit travel 3 so the fruit is conveyed/advanced in a direction 3 towards the lanes 300.

An orientated position and/or aligned position 14 is defined as the major axis 17 being horizontal and perpendicular to the direction of travel 3 of the fruit down the incline surface 111. For example, where rollers 114 are used, the major axis 17 will tend to be parallel to the axis of rotation 115 of the rollers, once the fruit is aligned.

Where items are not prolate, the conveyor tends to allow fruit gently move in the advancement direction with reduced tumbling (leaving the support surface(s)) or bruising.

Preferably the conveyor supporting surfaces is a belt, and preferably the belt is a substantially planar surface. In some embodiments the rising surface or rising surfaces is a belt, walking beam or other conveyor, drum roller, or the like.

In other embodiments where the conveyor 110 is formed from a plurality of rollers, the rollers form on average a downwards inclined surface, the rollers having static interposed supports. However, each roller will have a supporting surface 111 configured to support fruit. Each roller will be running in a direction so that the supporting surface 111 is moving in a direction 4 up the incline. For example, if viewing from the side, the incline is going downhill from left to right, the rollers/conveyor 110 will be running in an anticlockwise direction.

In other embodiments, the inclined surface 111 may be formed from a conveyor belt that does not have a rotational aspect perpendicular to the direction of travel. The conveyor 110 may rotate, or travel around, about a single plane, for example like a luggage carousel conveyor belt.

The rollers may comprise of one or more of a plurality of cross sections. For example, in one embodiment the rollers are of a circular cross-section, whereas in other embodiments the rollers may be of a polygonal cross-section.

The aligner 100 comprises dividers 301 extending towards the off take zone 103. The dividers 301 act to partition the stream of fruit. The dividers form lanes 300 at the off take zone 103. The dividers 301 are configured to divide incoming fruit down the conveyor 110, into single file streams of fruit. Each lane 300 allows only one piece of fruit across, and one or more fruit get serially stacked adjacent each other along the lane 300 in the direction of fruit travel 3. The lanes 300 are preferably of a similar width to the major axis 17 of the fruit.

Where fruit are not prolate, the conveyor tends to allow fruit to gently move in the advancement direction with a low amount of tumbling or bouncing. I.e. the fruit tend to stay in contact with a supporting surface, and not leave the surface to bounce or climb over other adjacent fruit, which could cause bruising or damage to either fruit.

The lanes 300 are configured to locate individual fruit to known locations so they can be picked up, preferably via a repeatable mechanical process, for transfer to a pocket 28 in a tray. The lanes 300 comprises an entry region 302 configured for an item to enter into said lane 300. The entry region 302 facing up the conveyor 110, open to the stream of fruit. The lane 300 also comprises an exit region 303, opposite the entry region 302 and towards or at the end of the lane 300. The exit region, as described above, be share the same space as the off take zone 103 that is configured for fruit to be removed from said lane 300. In alternative embodiments, the exit region 303 overlaps with the off take zone 103. This may be in cases where the items may travel down past the end of the dividers.

The dividers 301 are preferably vertical. However it is envisioned other angles of dividers may be used also. For example to keep fruit of the same size/weight but different lengths, in the centre of the lane. The dividers may comprise other features, such as centring flaps that are biased towards the centre of each lane 300 so that the fruit is centred within the lane 300 no matter the dimension or width of the fruit with respect to the lane.

The dividers can be any length—i.e. aligning only a single fruit in each lane 300 at a time, or covering the entire conveyor 110. In a preferred embodiment the dividers 301 cover about half of the conveyor 110. For example in one embodiment the divider is 300 mm long, and the conveyor is 600 mm long and a direction of the fruit travel. This allows the fruit to pool 16 above the entry regions 302, ensuring a good distribution to each lane 300, as well as an appropriate level of accumulation of fruit above the lanes.

The backwards travelling conveyor 110, and/or declined surface(s) 111, aids in reducing potential damage which could occur if the conveyor 110 was not inclined or not running backwards. This would occur if fruit bridged between a divider 301 at the entry regions 302 of two lanes. An inclined backwards travelling surface, will try to pull the fruit away from the divider 301, allowing the fruit to naturally tumble around the divider 301 until one fruit gives way and enters into a lane 300. In the same situation with an incline belt, or forward a running belt, or combination of both, fruit would be driven into the edge of the divider 301 intermediate the entry region 302, potentially causing bruising or scuffing to the fruit.

If a single piece of fruit is rotating on the conveyor (i.e. no fruit accumulated behind it) the rotating fruit may be quite unstable in its rotation. Therefore, it is beneficial to have at least two pieces of fruit in each lane 300 during operation.

There will be a preferred angle for the sloped surface of conveyor 110. If the conveyor 110 is too steep, fruit can climb over each other. However, this could be overcome by putting a top/lid (not shown) over top of the conveyor 110. The angle may be between 1 and 60 degrees. Or the angle may be determined by simple trial and error adjustment of the conveyor until a desired outcome is achieved.

If the conveyor 110 is too shallow, the fruit travel may not travel in the advancement direction, and may climb back up the conveyor 110 towards the incoming fruit.

In one embodiment, the conveyor 110 comprises a surface with a slope of two angles. I.e. the conveyor 110 is divided into this two sections, a steep section 116 and a shallow section 117 as shown in FIG. 6. In one embodiment, the slope of the conveyor is able to adjusted either prior to receiving items, or on the fly. In one embodiment, each section of slope is able to have its angle of slope adjusted.

The steeper section 116 is preferably located at or towards the exit regions 303 of the lanes, where the fruit are removed into the trays. The steeper angle aims to prevent the fruit climbing back up the belt.

The shallower section 117 is preferably located at or towards at the top (higher end region 112) of the conveyor, near the entry region 302 and/or above, to allow the fruit to pool gently and distribute across the lanes 300 evenly. Occasional fruit may climb back up the conveyor 110, however it generally will become unsettled again. The fruit may become unsettled by running into a dead plate (not shown) or another fruit. Once unsettled, the fruit tend to roll back down towards the entry regions 302 of the lanes. A dead plate is a non-moving surface between two moving surfaces, typically to span the gap created by the roll over ends of the conveyors, allowing for the smooth transfer of products from one conveyor to another.

The angle and speed of the supporting surfaces 111 will define the how efficient and effectively the aligner works.

In one embodiment, the angle from horizontal for orientation area/area 116 at the lanes 300 is between 1 to 60 degrees. More preferably the angle is between 5 and 30 degrees, and in one embodiment is 18 degrees.

In one embodiment, the angle from horizontal for the pooling area 117 above the dividers is between 1 to 30 degrees. More preferably the angle is between 2 and 25 degrees, and in one embodiment is 5 degrees.

In one embodiment, the speed of the surface(s) is between 20 mm/s to 1000 mm/s. Preferably the speed of the surface(s) is between around 100/s. The ideal speed will depend on the characteristics of the items, the angle of the conveyor, and other desired traits of the system.

The surface finish of the support surfaces is not critical, but there should be enough traction for the fruit to ensure they rotate, and not be so rough that it damages the fruit.

At the exit regions 303 (where lanes are present) and, in some embodiments, at off take zone 103, the fruit are still rotating due to the rising movement of the support surfaces 111 of the conveyor 110. Preferably the items are able to be retained at the off take zone 103 (at or near the same location at the exit region 303). Fruit may be removed directly from the conveyor at the off take zone by a gripper of a transfer device, or maybe transferred to a transfer region 404 first. Rotating fruit may be difficult to pick up. As such in some embodiments, there is an off take zone 103 (at or near the same location at the exit region 303) and a transfer region 404 that is sometimes separate for the exit region 303, and has the ability to hold items in a stationary, and non-rotating manner.

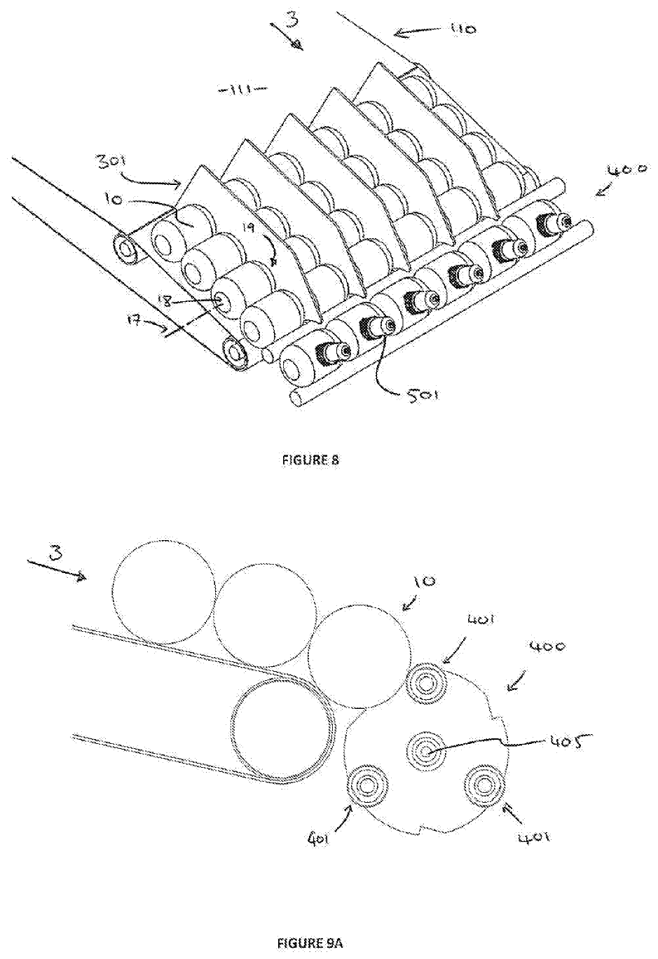

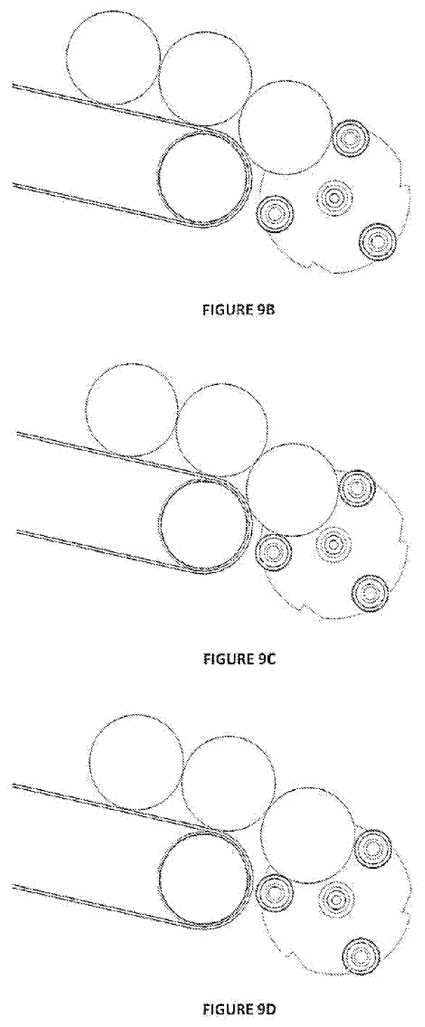

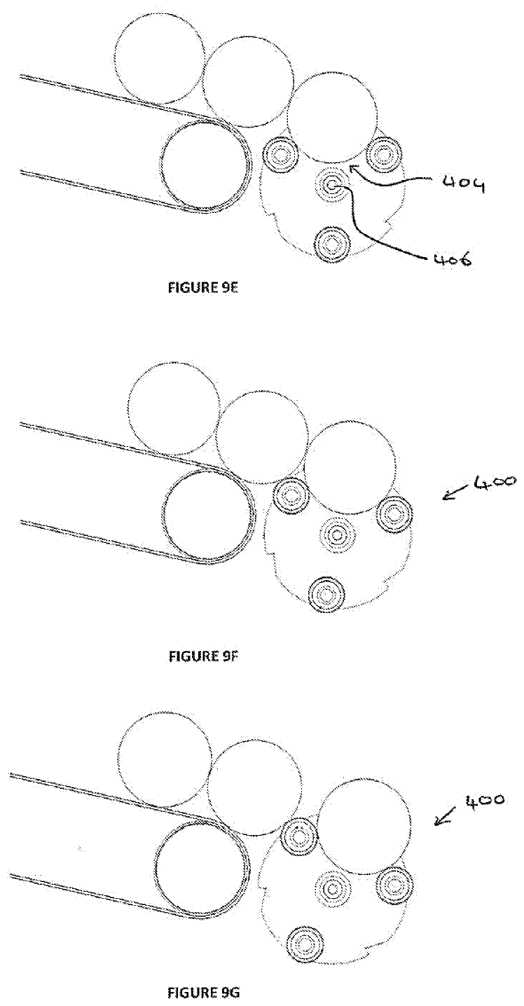

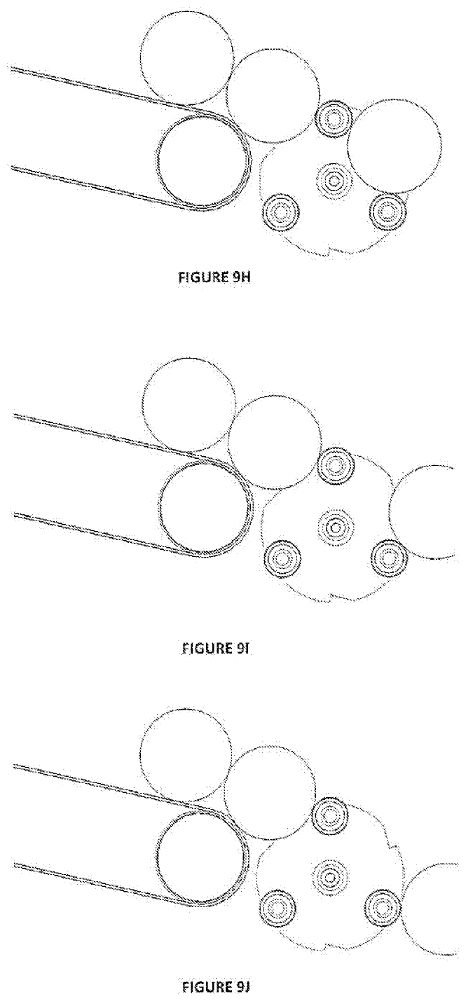

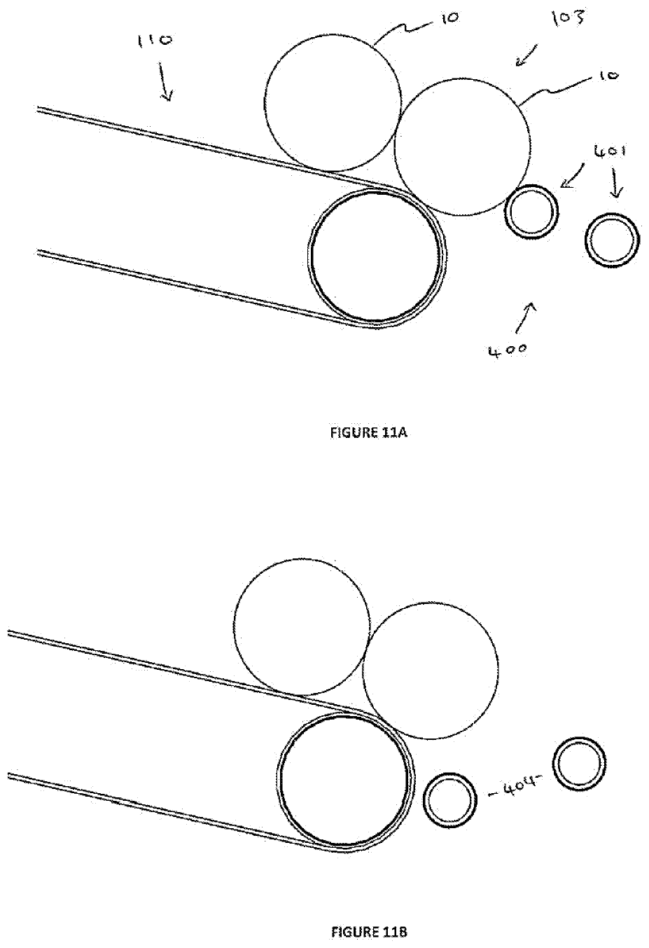

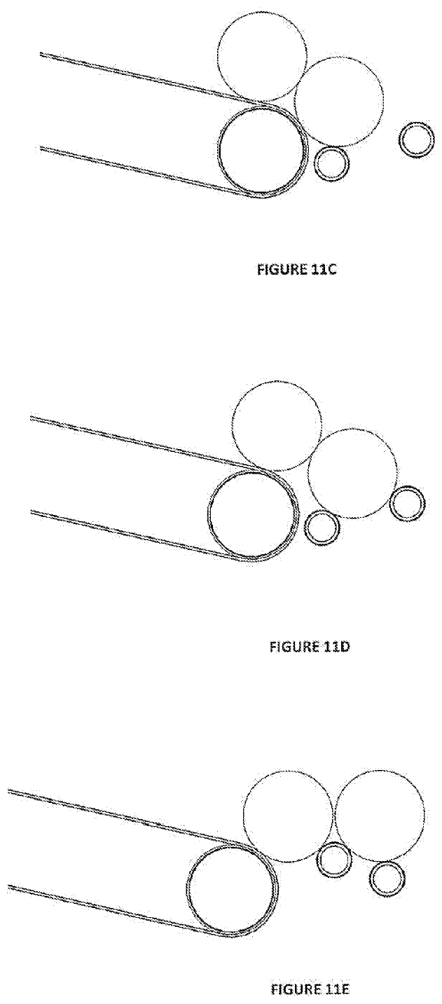

The exit region 303 is located at or near the exit regions of the lanes. A holder 400 retains the fruit at the off take zone 103, and prevents the fruit from tumbling off the conveyor 110, as shown in FIGS. 9 and 11A.

When required, the holder 400 is actuated so that it receives/takes fruit from the off take zone 103 and can hold the fruit in a stationary position, as shown in FIGS. 9G and 11E, ready for a transfer device 500 to pick up the fruit. The transfer device 500 can then transfer the fruit from the holder 400 to a tray 20 or other preferred location. The transfer device in some embodiments can solely, or also, transfer items from the holding region/conveyor directly to a desired location, such as to a tray.

In some embodiments a tray may have multiple pockets, where some of those pockets are not aligned in the direction of the other pockets. With these trays, the transfer device 500 needs to rotate/orientate the fruit from their aligned position, to the pocket orientation. Having the fruit all aligned in the same orientation allows the transfer device to accurately and reliable shift the orientator to match the pocket orientation.

The holder 400 allows the fruit to be stationary (rather than rotating) to make it easier for pick up for the transfer device 500. The holder may rotate the fruit to a preferred alignment/orientation. For example, the holder may comprise rollers which can be idling, fixed or driven.

The fruit is preferably removed from the off take zones 103 in a manner that keeps the trailing/held fruit settled. I.e. if a fruit is removed directly from the holder 400, without the holder 400 retaining the adjacent and trailing fruit at the off take zone 103, the trailing fruit would rush into the gap where the held fruit was removed, and the fruit in the lanes 300 would potentially un-settle themselves. The time to have the fruit settled is a limiting factor for machine speed so reducing unsettling is important.

Preferably the holder 400 comprises three functions. Firstly, to retain fruit at the off take zone 103, secondly to remove fruit from the off take zone 103, and thirdly to hold fruit at a stationary location for removal by a transfer device. Once the holder has removed fruit from the off take zone 103, it is able to then hold the fruit in a stationary position. The fruit may be caused to rotate or roll when in the stationary position. This may be done to achieve a particular secondary orientation of the fruit, along the major axis.

A fourth optional function of the holder 400 is to insert fruit held, back into the off take zone 103.

In some embodiments, the holder 400 may only comprise one elongate member configured to retain items at the exit region.

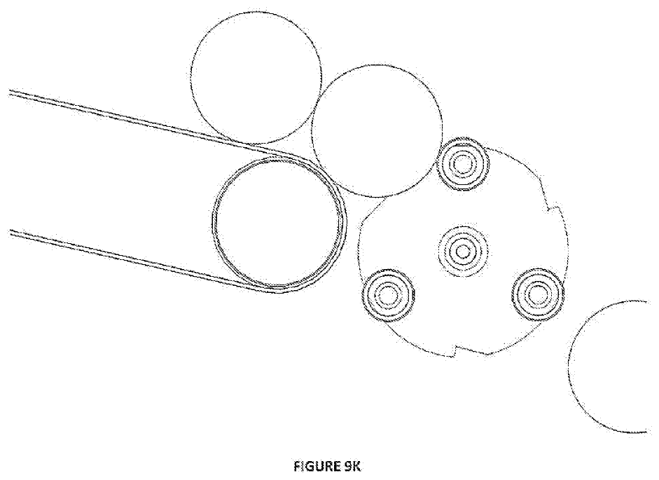

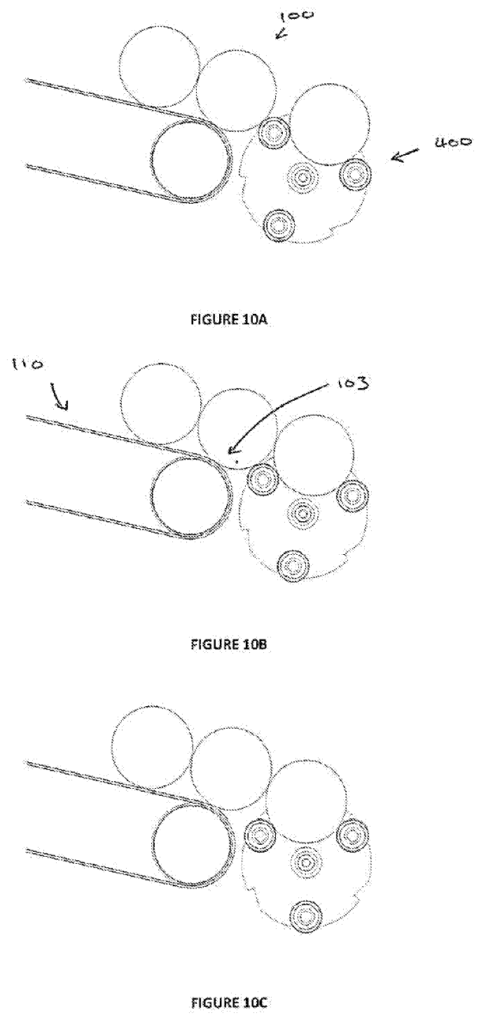

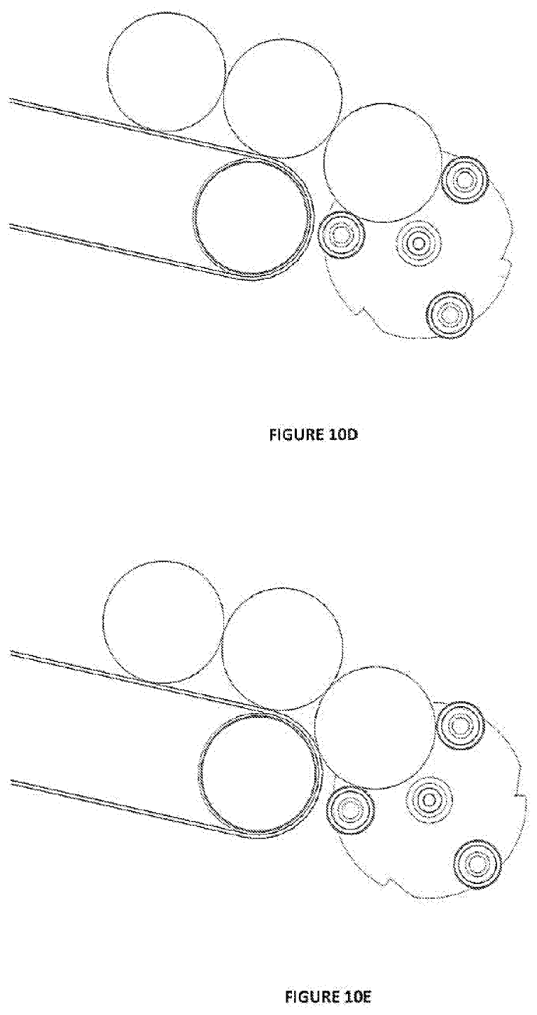

Two examples of embodiments of holder 400 are shown in the figures. A rotation style holder—FIGS. 9 and 10, and two member drop bar style holder—FIG. 11.

Where the rotation style holder has holding members 401 that are of a fixed spacing to each other as the holding members rotate or oscillate about a pivot point 405. The drop bar style holder has holding members 401 that translate relate each other.

Generally, both embodiments of holder 400 comprise similar features of having elongate holding members 401 that have their elongate axis horizontal and perpendicular to the advancement direction 3. The members are aligned across the off take zone 103, to contact fruit at off take zone 103 when fruit are present. By doing so, the holding members 401 retain the fruit at the off take zone 103/exit regions 303, and by doing so, retain any upstream fruit within the lanes 300.

The holder 400 may be configured to retain and hold fruit from all of the lanes 300 at one time, or may be configured for individual lane 300 actuation. Individual lane 300 actuation means that the holder 400 can retain fruit for separate lanes 300 individually, and likewise remove fruit from separate lanes 300 individually. I.e. it may remove fruit from one lane, and retain fruit at an adjacent lane.

The rotation style holder 400 comprises either two members that oscillate back and forth about a pivot point, or three holding members 401 as shown in FIGS. 9 and 10 that rotate continuously, or semi-continuously, about a pivot point. The holding members 401 are configured to rotate about a central holding pivot point 405. In the three member configuration, the holding members 401 move between function as retaining members, to retain fruit at an exit region, or holding members, to hold fruit stationary for the transfer device 500, as the three members rotate about the pivot point. At some instances, a holding member may both hold a fruit and retain a fruit.

A holder comprising three members could be used for dropping fruit directly and continuously into the pockets, i.e. no transfer device 500 is used. This may also be used counting/metering fruit into a box or other conveyor or the like. A continuous forward operation may require mechanical blocking of fruit for trays having rows containing less fruit than the number of lanes, unless other methods are employed. Such other methods may be the tray 20 is able to laterally shift to the correct position to line up the pockets 28 with the lanes, the lanes 300 are able to laterally shift to divert fruit to the correct pockets, or the holder is able to laterally shift to divert fruit to the correct pockets, or a combination or one or more of the above.

In one embodiment the drop bar style holder, as shown in FIG. 11, comprises two members, a first member to retain fruit at an exit region and support a fruit at a transfer region, and a second member to aid in supporting fruit at the transfer region. The members 401 are configured to actuate or be actuated between two positions, where the members 401 can shift their position relative to one another.

The two member embodiment drop style holder, or two member oscillating style holder has an advantage compared to the three member rotation style holder as the members 401 are able to be positioned closer to the tray 20 underneath.

A further advantage of the two member oscillating style holder is that not all of the fruit is required to be removed from the holder 400 with the transfer device 500 every actuation. Because when the holder 400 rocks back with a fruit still held, the holder 400 will push any held fruit back into the exit region 303, and any retained fruit at the exit region will be pushed back up the lane.

The holder 400 may have a continuous movement, a backwards and forwards movement, and/or may be actuated according to the system requirements.

The two member rotation (rocker) holder has similar holding members as previously described, but they are set a set distance apart like the rotating holder. However the rocker holder oscillates back and forth instead of rotating. The rocker holder also has the benefit of being able to get the tray 20 closer to the holding members as the holder is more low profile.

The rocker holder and drop bar holder are able to have different styles/configurations of holding members as the each holding member 401 performs the same function continuously, as compared to the three member rotation holder, in which the holding members shift function as they rotate.

Typically the trays have pockets aligned in the same direction, so the holder and/or transfer device can place the items directly into the pockets without any change in orientation of the item. In some embodiments a tray may have multiple pockets, where some of those pockets are not aligned with the direction of the other pockets.

The holder 400 in some embodiments may be configured to shift fruit from the held position, on the holding members, back onto the conveyor, at the exit region 303. An example of this is shown in FIG. 10.

In some embodiments, the holder may continually rotate the fruit to align the fruit's elongate axis. In some embodiments, the holder may rotate in one direction when fruit is to be transferred from the transfer region, and may then rotate the opposite direction (preferably counter clockwise, towards from the conveyor) when either retaining fruit at an off take zone, and/or to put fruit from the holder back into the off take zone.

Either style of holder may utilise a transfer device 500 to relieve the holder 400 of its held fruit, or the holder itself may drop off the fruit directly into a pocket/tray.

In one embodiment, the dividers extend to the holders. I.e. the holder dividers ensure fruit is maintained in its lane, when fruit is on the holder. The holder dividers may be integral with the dividers on the conveyor, and not be secured to the holders; or may be a separate divider located and fixed only on the holder 400, but are complementary and colinear to each upstream lane.

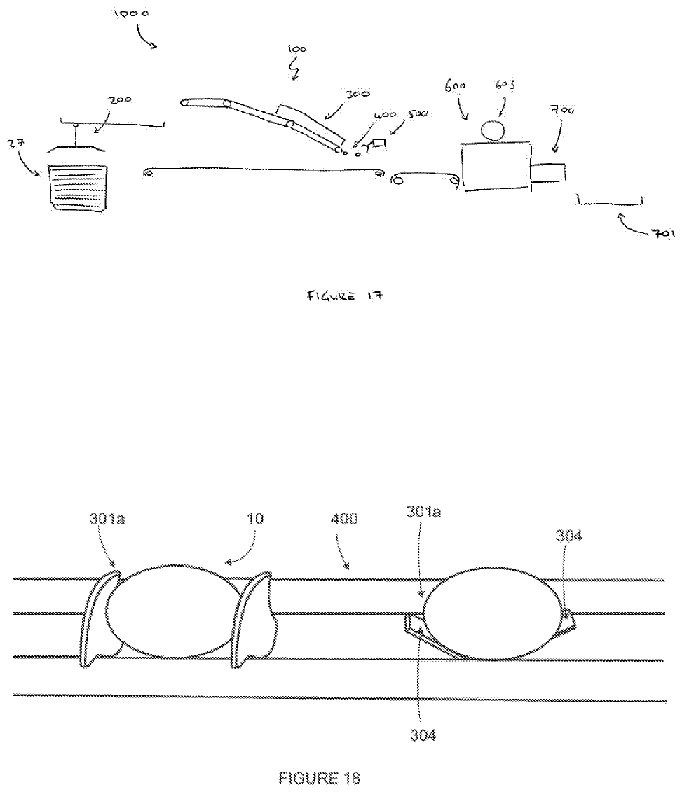

Two examples of a holder divider located solely on a holder are shown in FIG. 18. One configuration is a vertical walled holder divider 301a, to keep the fruit within a lane formed by the two walls.

The other configuration is a vee shaped holder divider 301b that holds the fruit in the valley of the vee shape. The vee shape holder divider 301b may be flexible, to reduce impact to the fruit as it comes into contact with the holder divider 301b. The holder divider 301b is configured to self-centre fruit held within the vee shape, so the fruit tends to fall and be held laterally, within the centre of the vee.

An example where the walls 301 of the lanes 300 extend from the conveyor over the holder 400 is not shown. The divider holders may be useful in embodiments where the holder is able to translate laterally to drop fruit into appropriate pockets, not in line with the fixed lanes 300.

The holder dividers in one embodiment may be fixed to the holder, but not be fixed to the holder members 401. This allow the members 401 to spin/rotate about their elongate axis if required for further alignment of fruit. The holder dividers will be centrally located intermediate the members 401, to prevent laterally shift of the fruit with respect to the members, but the holder dividers will the restrict contact of the fruit with the members. Holder dividers that allow the held fruit to spin will be appropriate for the two and three member rotation/oscillation style holders where the gap between the members does not change.

The spinning/rotating holding members (about their own elongate axis) may be present in any of the holder configurations. One or more holding members may spin.

The holder dividers can be located in numerous configurations. For example, in the FIG. 18, the vee holder divider is shown intermediate the holding members, and below the item. FIG. 21 shows the holder divider intermediate the conveyor and holding members, and below the item. In other embodiments the holder divider is located to the side of an item, or above an item. For example, the holder divider is located above the holding member 401 and has its open vee shape facing the conveyor. In another embodiment, the open vee shape is facing downwards towards the holding member, and the item falls in between the holding member and holder divider. Accordingly, the transfer device, if present, will need to be configured to be able to extract the item from the transfer region. In other embodiments, the holding member can actuate to allow the item to fall away without being hindered by the holder divider. The important aspect of the holder divider is that is can align prolate items along their major axis, as well as keep item laterally located—to do so, there needs to be contact of the item with the holder divider. As such the holder divider needs to be shaped and configured accordingly depending on the item. The holder divider can be used with one or multiple holding members 401.

The holder divider in one embodiment (when being used with for example, kiwifruit) is vee shaped with lateral walls 304 symmetrical to each other and 50 degrees off the horizontal. Steeper or shallower vee shapes may also be used, and have been used, successfully. The lengths of the lateral walls 304 (forming the width) of the vee holder divider are not critical, as long as there is adequate contact between the lateral walls and the item, likewise for the depth of the item.

In other embodiments it may be desired to remove items directly from the off take zone 103 to be transferred to the desired location (i.e. a tray 20 or carton), bypassing full support by the holders 400.

In another embodiment, the holder 400 is used to retain the items 10 at or near the off take zone 103. For example, there may be only one holding member 410 acting as a retainer to retain items at the off take zone 103, in this example the off take zone 103 is described as an off take zone 103 as the item is still supported at least partially by the conveyor 110. The off take zone 103 is overlaps with the transfer region 404 in this embodiment. The transfer device 500 is configured to transfer the items from the off take zone 103/transfer region 404, whilst the item is retained by a holding member 401, to be transferred to the desired location.

The item at the off take zone 103 may be supported by the rising support surface(s) 111 and as such the item may still be rotating. The rising support surface(s) 111 may temporarily stop in some embodiments to allow the transfer device to grip the item when the item is not moving. In other embodiments the off take zone 103 may comprise a stationary platform (not shown) raised above the rising support surface(s) 111 so that item 10 is then supported by the platform to allow the item to stop rotating. The item 10 may still be retained by a holder 400, or other similar mechanism that can stop an item from falling off an angled surface. The platform could be described as shim or like thin element that the item can easily transfer onto, under its own momentum or gravity.

In the above embodiment, where there is only one holding member 401 acting as a retainer, the system may also comprise a holder divider intermediate the off take zone 103 and the retaining holding member 401. For example, like the holder dividers 301a/301b previously described. An example of this is shown in FIG. 21. In one embodiment, the one holding member 401 is configured to actuate to allow the item to fall off or be egressed by the holder, as shown in FIG. 22. In combination, or alternatively, a transfer device can be utilised to egress the item from the holder diver/holder/offtake zone.

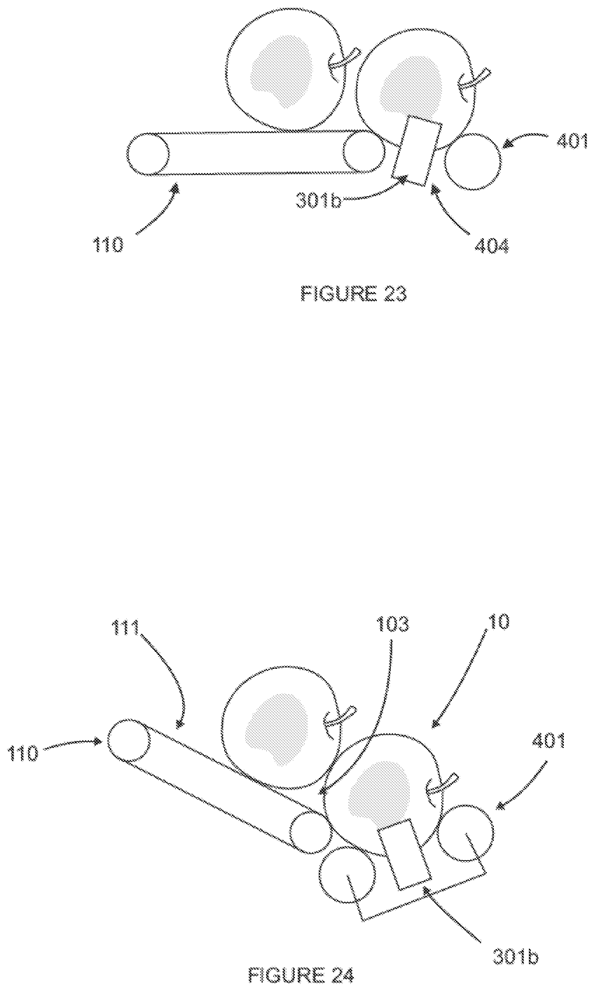

An example with a holding member 401 adjacent an offtake zone is shown in FIG. 23. In this embodiment, the conveyor is not a rising conveyor. Items are merely conveyed to the off take zone. At the off take zone the items can fall into the transfer region 404 intermediate the off take zone and holder member 401, where preferably a holder divider is located. Such a holder divider as holder divider 301b. The holding member is one embodiment is configured to rotate. In one embodiment, the rotation of the holding member is driven, in other embodiments it is passive and driven by the item rotating due to contact with the conveyor supporting surfaces. The vee shaped holder divider 301b, along with the rotation of the item by the conveyor and/or roller 401, aids in orientating prolate items to have their elongate axis parallel with the roller 401.

In further embodiments the holder 400 comprises the two holding members 401, that, in a preferred embodiment, have at least one holder divider intermediate the two holding members, that relates to a respective aligned lane 300. The two holding members 401 can receive an item 10 from the off take zone. The item can be egressed via a transfer device and/or actuation of the holding members. In one embodiment, the item is still partially supported by the rising support surface(s) 111, in other embodiments the item is not in contact with the rising support surface(s) 111. An example of this embodiment is shown in FIG. 24. The two holding members 401 in this embodiment are fixedly located relative to each other, however in other embodiments, one or both may move.

In alternative embodiments, the items are removed directly from the conveyor supporting surfaces. In such an embodiment, preferably lanes with dividers 301 are utilised. Once the items have left, or at the end of, the lane 300, at the exit region 303 they enter the off take zone 103 which is in this embodiment, the same as the transfer region 404. At the transfer region 404, preferably a holder divider is located. The holder divider is at least configured to laterally align the items at the ends of the lane, and/or ensure any prolate items stay aligned (elongate axis perpendicular to upwards direction of conveyor) whilst they are supported on the upward moving supporting surfaces. The holder divider in one embodiment is the vee shaped holder divider 301b as previously described. In other embodiments the holder divider merely encompasses two touch points that are able to engage with an item so that the item tends to stay orientated when it is prolate and rolling. In this embodiment, the item at the exit region tends to stay orientated when a similar item is behind the item at the exit region. In this embodiment, the transfer device 500 is configured to remove items directly from the supporting surface or a dead plate that is supporting the item at the exit region.

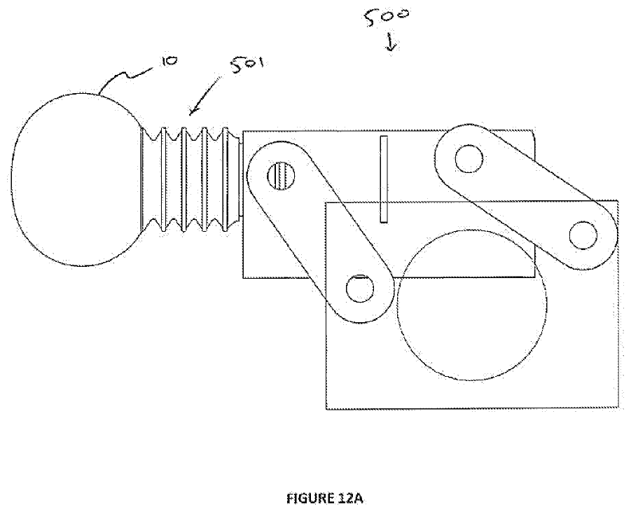

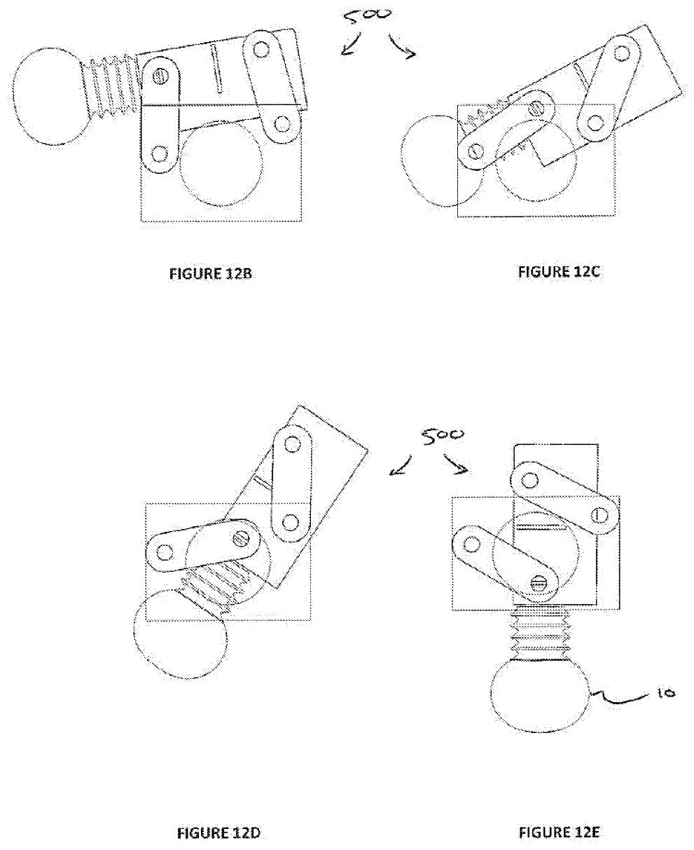

One example of a transfer device 500 is shown in FIG. 12. The transfer device 500 picks up a fruit that is held by the holder 400, and transfers fruit to the appropriate location, i.e. a pocket, on a tray. It is envisaged that the movement of the transfer device 500 can be configured in many different ways. I.e. there may be one transfer device 500 purely for shifting a fruit from one holder location, to a specific located pocket, or the transfer device 500 could move fruit from the holder to any pocket 28 in any location. I.e. the complexity and movement capabilities of the transfer device 500 could be simple or advanced. In some embodiments the transfer device may support an item, whilst the previous item supporting surfaces move away, so the transfer device allows the item to separate from its previous supporting surfaces.

In one embodiment, the tray 20 moves to meet the exit regions of the lanes. In other embodiments dividers move to match the pockets 28. In other embodiments the transfer device 500 moves between the exit region and the pockets. In further embodiments, it is a combination of movement of the dividers, tray and transfer device 500.

Preferably the transfer device 500 utilises a gripper (not shown) or a vacuum cup 501. The gripper may be a robotic/mechanical hand known to the skilled person in the art. There are many variations of gripper that could be configured to support an item.

The vacuum cup 501 works optimally when a fruit stationary. As such the holder 400 preferably holds the fruit in a stationary position, where the fruit is not moving, for optimum grip/suction of the transfer device 500 to the fruit. In one embodiment, the transfer device 500 is as shown in FIG. 12. FIG. 12 shows a transfer device 500 picking up and placing a fruit. By stationary it is meant the location of the item is stationary the item itself may be moving, i.e. rotating, at its stationary position. The stationary position may be described as a presentable condition.

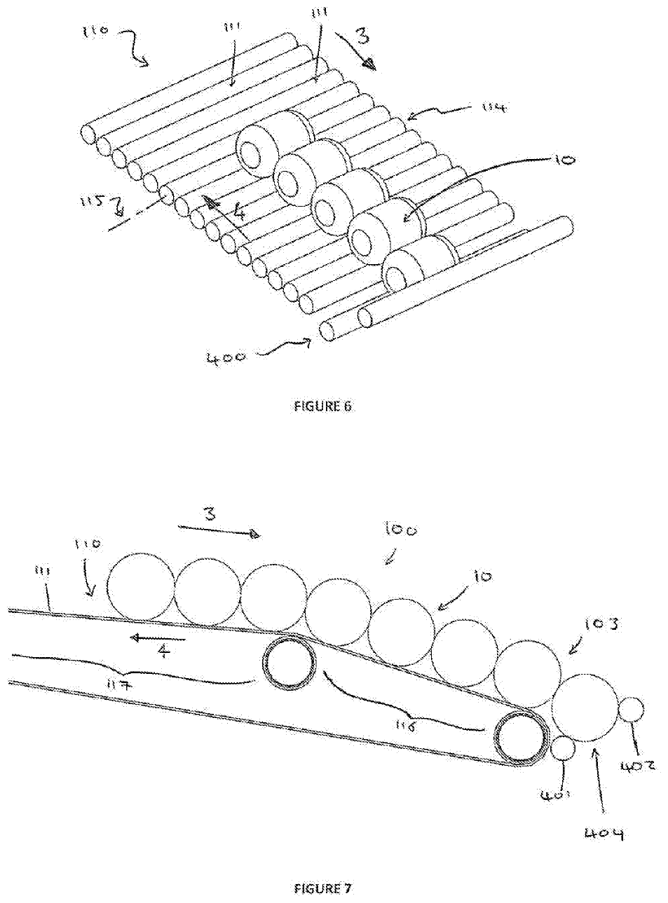

Preferably the transfer device 500 comprises a lateral row of vacuum cups as shown in FIG. 8 that relate to the exit regions of the lanes. The transfer device is configured to transfer fruit from the respective positions on the holder 400 to the row of pockets 28 of a tray.

In other embodiments the transfer device utilises a gripper hand or arm or other mechanism that is not a vacuum cup, that is configured couple/secure/engage with an item and move it.

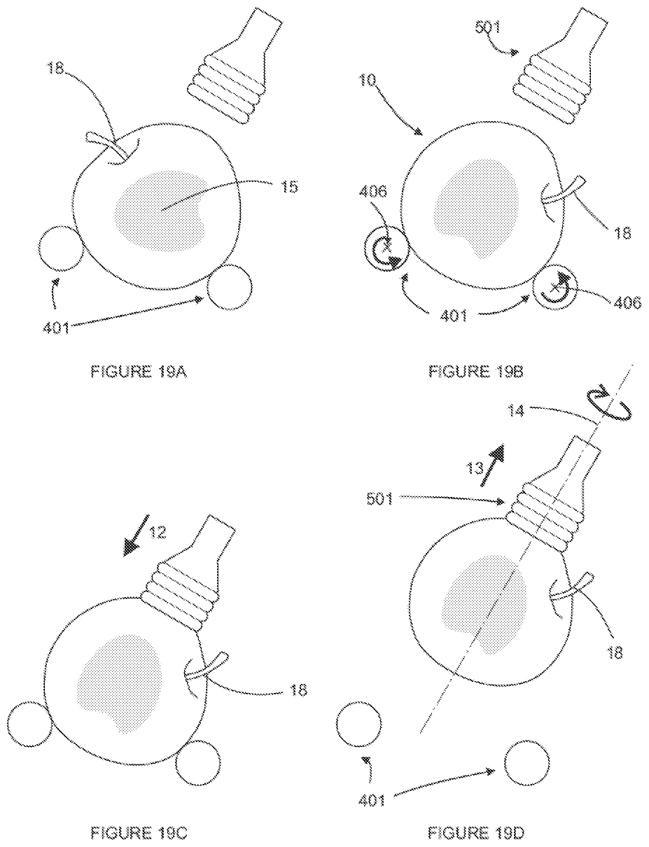

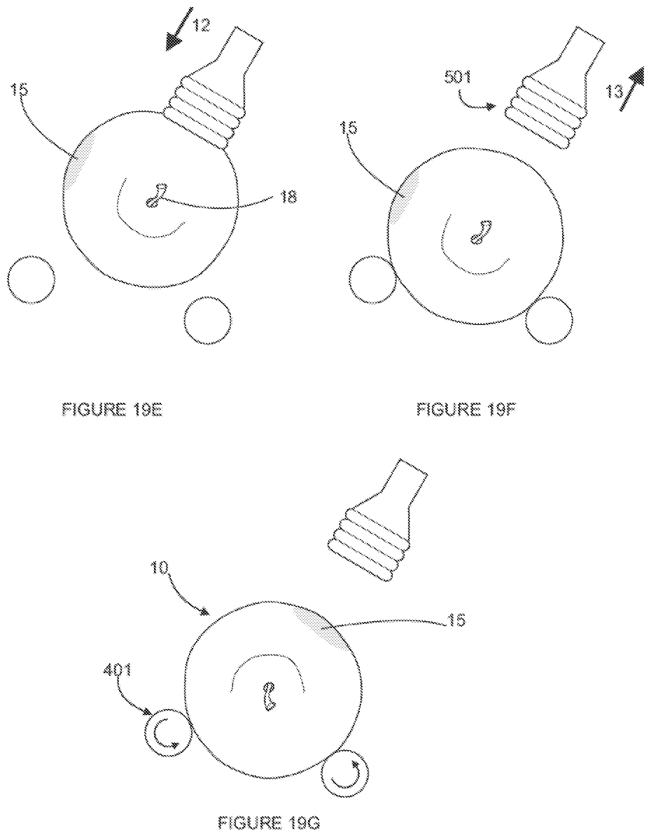

FIGS. 19A-G show an embodiment of a further aspect relating to an alternative item aligner. This aspect may be part of the system already described, or independent of the said system. This aspect is a method of orientating items 10 (such as fruit, either prolate, spheroid of rollable) utilising rollers 401 and a device similar to the transfer device described previously. The transfer device is or comprises a mechanism to hold the items, such as gripper hand or vacuum cup. Any suitable mechanism that is configured to be able to lift an item off a support surface, preferably without damaging the item. In a preferred embodiment a vacuum/suction cup 501 is used that utilises suction to create a vacuum between the cup and the item, to therefore couple the item 10 to the cup 501. The purpose of this aspect is to orientate a received item 10 so that a specific side is presented in a specific first direction. For example, an optimum region 15 is presented in an upwards direction as shown in FIG. 19 G. This optimum region 15 may be the best side of an item, such as the reddest side of an apple.

The item 10 is first received onto rollers 401 as shown in FIG. 19A. The item is orientated via rotating the item 10 about two axes that are perpendicular to each other. Where rotation about a first axis is achieved by rotating the item on rollers 401 as shown in FIG. 19B, and rotation about the perpendicular second axis 14 is achieved by rotation of a vacuum cup 501 rotating whilst supporting the item 10 clear of the rollers 401, as shown in FIG. 19D. Clearing the item from the rollers may be achieved via the rollers dropping away from the item, or the cup lifting the item away from the rollers. Either way, the item is separated from the rollers, so it is clear to rotate free from hindrance.

The rollers may be of the configuration of the holding members 401. The holding members 401 are able to hold an item by supporting the item on their upper surfaces. Both holding members 401 are able to rotate about a rotational axis 406. One or more of the holding members 401 are rotatably driven to be rotated about the rotational axis 406.

The first rotational axis may be parallel with the rotational axis 406 of the rollers 401. The first rotational axis may be at the centre of rotation of the item supported by the holding members 401. The first rotational axis may rotate an item to a first orientation.

The second rotational axis 14 is preferably perpendicular to the 1st rotational axis, and allows the item to be rotated to a second orientation. The rotation about the second rotational axis 14 is achieved by a vacuum cup 501 that is configured to couple to, and pick up the item 10 from the rollers 401, as shown in FIG. 19C, to lift the item 10 off the supporting surfaces/rollers 401. Once the item 10 is clear of the rollers 401, as shown in FIG. 19D, the vacuum cup 501 is configured to rotate about the second rotational axis 14 until the optimum side is in a direction perpendicular to the rotational axis of the item (the first rotational axis, in this embodiment, the stalk 18 is on the first rotational axis). Once the optimum side 15 is in the correct position, the vacuum cup 501 places the item back onto the rollers 401 in this second orientation, as shown in FIG. 19E.

Once the item 10 is placed on the rollers 401 in the second orientation, the vacuum cup 501 decouples from the item 10 as shown in FIG. 19F.

If the item is in the correct orientation, the process stops here. If the optimum side is not yet presented in the first direction, then subsequently after the previous step, the rollers 401 are is configured to again rotate about the rotational axes 406, to rotate the item 10 to a third orientation, so that the optimum side 15 is presented in the desired first direction, as shown in FIG. 19G

The vacuum cup 501 is able to actuate between a first and second position, where in the first position the vacuum cup 501 is configured to attach to an item that is supported by the rollers 401, and in the second position, the vacuum cup 501 is configured to lift the item 10 off the rollers 401 to a clearance position where the item 10 may be rotated about the rotational axis 14. It is envisaged that there are many ways to actuate the vacuum cup 501 and the lifting 13 and placing 12 direction. In a preferred embodiment the vacuum cup 501 is actuated in a direction collinear with the rotational axis 14.

It is envisioned that the vacuum cup 501 may be of a plurality of different designs. The vacuum cup may be specifically configured to attach to the specific item 10 that is picking up and placing down.

Different transfer devices (i.e. vacuum cups or grippers) may be used for rotating the item in separate movements. I.e a first cup rotates the item once, and supports it back on to the rollers. A second cup may then separate the item from the rollers and rotate the item again. In a further embodiment, the second cup, or another cup, separate from the first cup, or a cup that performs the rotation, may transfer the item from the rollers to the plix.

In another embodiment the item may be transferred from the rollers 401 to a second set of rollers. The second set of rollers may be configured to then deposit the item into a plix or present an item to a gripper or vacuum cup for the item to be removed from the rollers to a plix or similar.

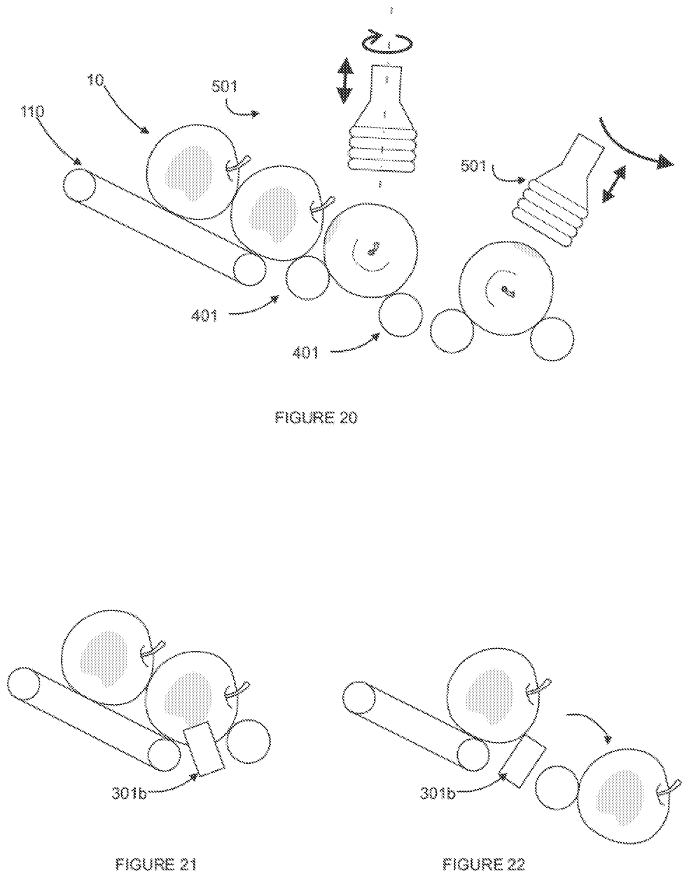

In one embodiment, the rotation about the horizontal axes may be performed by different sets of rollers. For example an item is located on a first set of rollers, and orientated to a first orientation. The item is then picked up by a vacuum cup or gripper or like mechanism and rotated to a second position. The item is then supported back onto the first set of rollers or onto a second set of rollers. If placed onto the first set of rollers, the first rollers would then transfer the item to a second set of rollers. Once an item is located onto the second set of rollers, the second set of rollers is configured to then orientate the item to a third orientation. From the second set of rollers, a gripper or vacuum cup is configured to then transfer the item to a plix or similar, or the second set of rollers themselves are configured to egress the item. By splitting the separate rotation into two locations, it would allow the process to be done faster. One way it may be achieved faster is because a subsequent item may then be transferred to the first set of rollers while the first item is still being held at the second set of rollers. See FIG. 20 for an example of a system that utilises two sets of rollers and two transfer devices.

There may be multiple vacuum cups along the length of the rollers 401. A vacuum cup may be configured to pick up an item when the item is at its ideal first position. There may be one vacuum cup configured to pick up items from a particular location, or they may be one vacuum cup is configured to move along the rollers picking up and rotating items. There may be one or more vacuum cups configured to move along the length of the rollers (along the direction of the axis of rotation 406) picking up items 10 when the items 10 are in a first orientation.

There may be multiple rollers 401 instead of just to rollers 401 as shown in the FIG. 19. The multiple rollers 401 may provide better support for softer items or items more prone to damage. Again, one or more of the multiple rollers 401 may be driven whilst the other rollers are passively driven from the item 10 rotating due to being rotated by the driven roller 401. In other embodiments the two or more rollers 401 may form a conveyor belt of sorts, where the shifting belt rotates the item 10. Alternatively, the rollers 401 are the axles for a conveyor belt. For example, there may be a conveyor belt about the rollers 401, and the belt supports the item 10.

The rollers may be driven by many different driver means such as an electric motor and a drivetrain system of some configuration.

The present invention may comprise optical means that allow a processor to determine when an item is in its first, second or third position, so the system knows when to actuate (rotate) the rollers 401, and actuate (lift/place and rotate) the vacuum cup(s) 501. The optical means may be an optical sensor that converts light rays into an electrical signal. As such the optical sensor is used to determine when an optimum side of an item is presenting in a particular direction. There may be multiple optical sensors, to pick up different sides of the item. In some embodiments there is a processor to determine the inputs from the optical sensors to determine what side of the fruit is the optimum side, and what rotation about what rotational axis is required to present the optimum side to the first direction. The optimum side of an item may depend on glossiness, colour, shape or other factor or characteristic. The automation of the system may be quite complex depending on the needs required. However, the basic premise is that an item is simply rotated about two axes of rotation to position the item into a third preferred orientation where an optimum region is presented in a first direction.

Once an item 10 has been orientated to a third orientation and may be removed from the rollers 401. The item may be removed either via the same vacuum cup 501, a different vacuum cup, or the rollers 401 may be actuated to drop off the item 10 in a manner as previously described in the specification with regard to the holder 400. Preferably the vacuum cup 501 lifts the item 10 off the rollers 401 and places the item in the same orientation into a tray.

The above aspect may be a step in the system as described herein. Where the holding members 400 receive an item 10 that has been aligned with its major axis parallel with the rotational axis 406. However, if the item is not prolate, or it is desired that item needs to be aligned to a different orientation, then the present invention of shifting the item 10 about two axes of rotation can be utilised.

In one embodiment, the system comprises, and/or utilises a stack of empty trays 27 from which an uppermost tray 26 may be removed from. The uppermost tray 26 is translocated from the stack of trays location, to a location where fruit may be subsequently deposited into the pockets 28 of said tray.

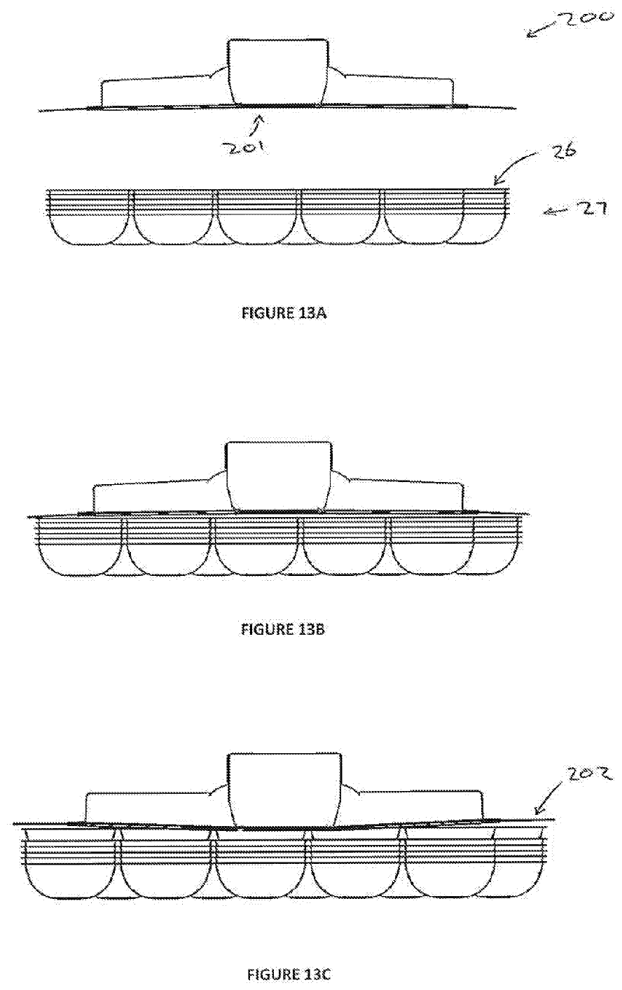

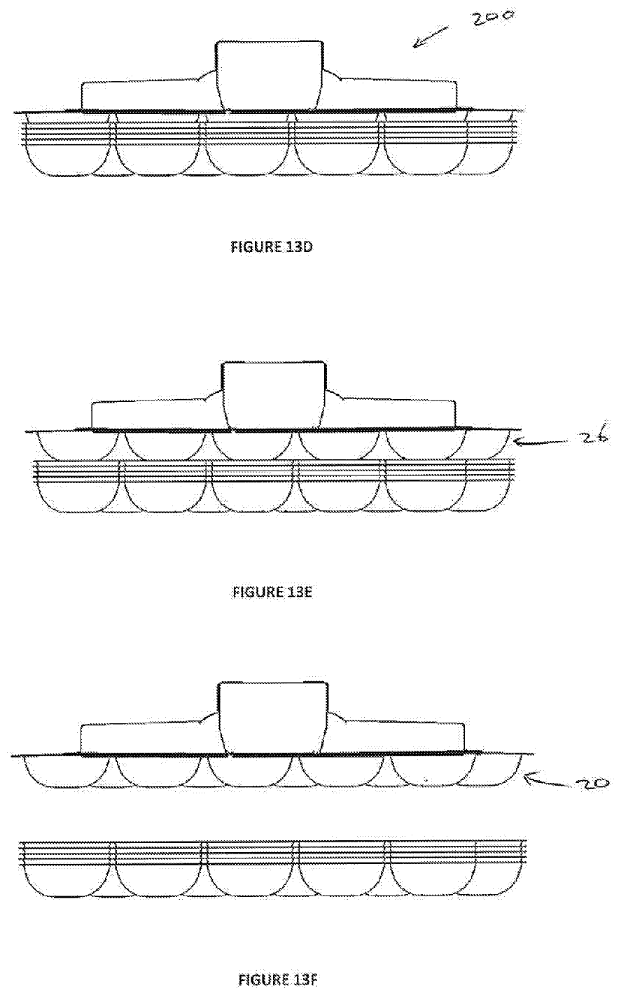

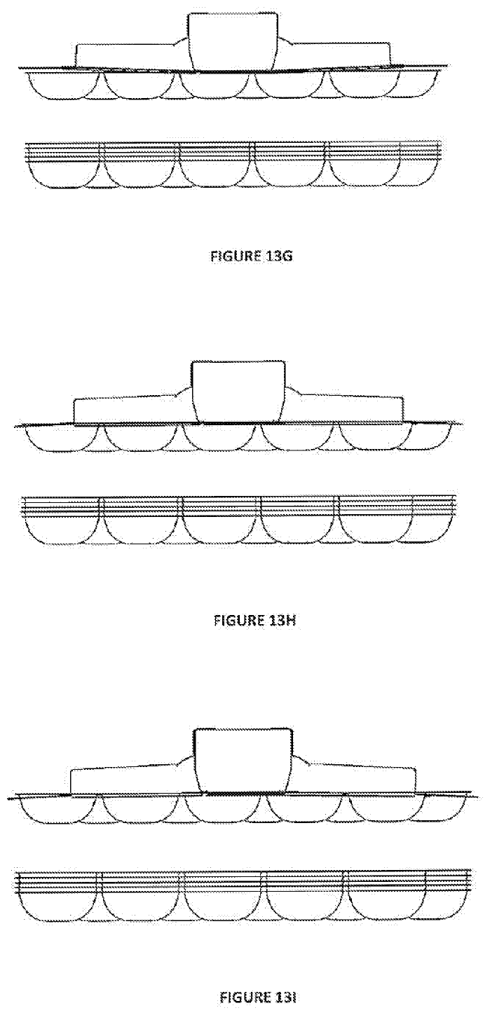

In one embodiment, the system comprises a tray device 200 that is configured to pick up a single uppermost tray 26 from a stack of trays 27, as shown in the series of FIG. 13.

In one embodiment, the trays are somewhat flexible and relatively thin. A known tray 20 in the industry is made by ALTO PACKAGING and is called the PLIX® POCKETPACK.

The tray device 200 comprises a vacuum system 203 that is configured to create a vacuum to be applied to a suction head/vacuum pad 201, as shown in FIG. 13. The suction head is able to be actuated adjacent a tray 20, so that the tray device 200 may engage with the tray 20 to subsequently remove said tray 20 from the stack 27. The suction head is configured to be attached an actuating member, such as a mechanical arm 204—to aid in translocating the suction head.

The apparatus further comprises an input member to co-act with the suction head 201 to de-nest such a topmost tray 26 from a stack 27 and/or an adjacent tray (one that is adjacent to, or stuck to the topmost tray). When the suction head 201 is lowered onto the top of the stack of trays 27, a vacuum is applied to the suction head 201 to conform somewhat to at least a portion of the shape of the tray 20; forming a seal to the contacted tray 20.

Preferably the input member 202 comprises movable lateral wings 202 that are configured to actuate for several cycles to loosen the uppermost tray 26 from the adjacent tray and ensure there is only a single tray picked up. The actuation is configured to be either vibration and/or oscillation. An actuation mechanism 205 comprising a servomechanism and appropriately configured levers, is used to actuate the lateral wings 202.

In one embodiment, the lateral wings 202 are composed from 3D printed plastic. In one embodiment, the lateral wings 202 comprise flaps (not shown), allowing conforming to the tray. The flaps are composed from a thin sheet of Thermoplastic polyurethane. In one embodiment, the lateral wings comprise a semi stiff road, such as fibreglass rods, to aid in holding the wings in place. The rods are flexible so to allow the wings to move sufficiently. It is envisaged that the lateral wings 202 could be composed and assembled from a variety of different methods and materials.

In one embodiment, an ejection member 206 is used to eject the uppermost tray off the suction head 201. This ejection member 206 is shown in FIG. 28. The ejection member is generally a member that is configured to be actuated to drive the tray away from the suction head/s. In other embodiments, the turning off of the vacuum to the suction head 201, is enough to cause separation the tray from the tray device 200 without the use of an ejection member.

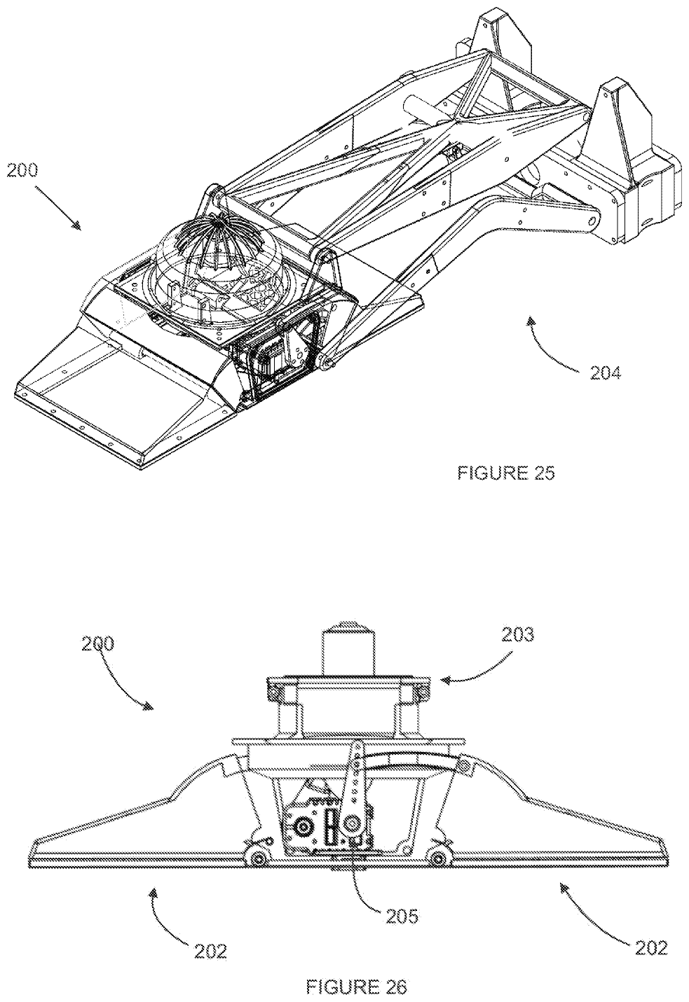

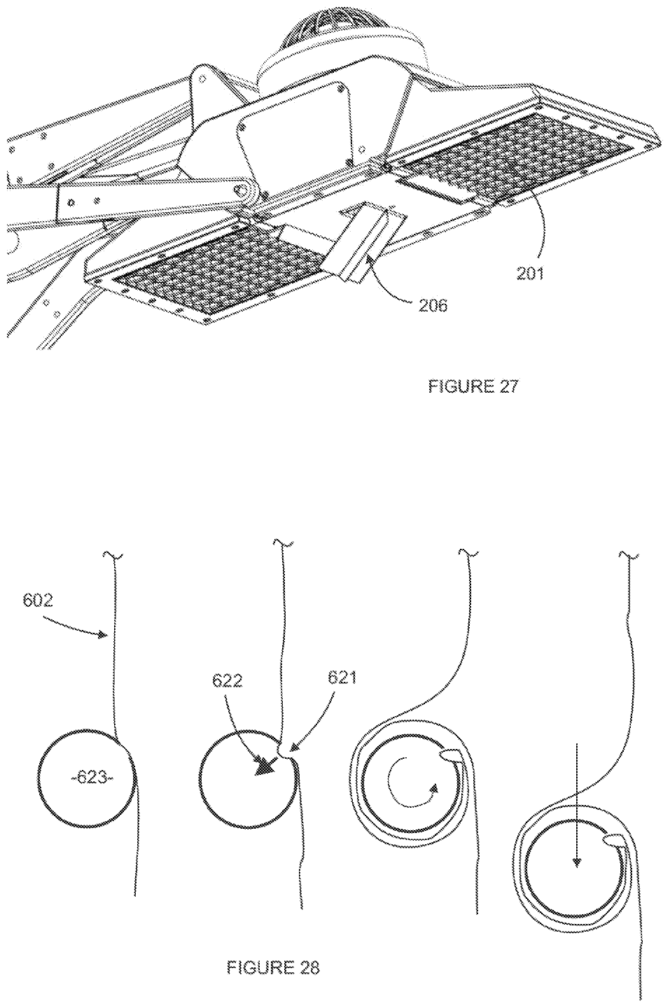

A simplified process of picking up a tray 20 is shown in the series of FIG. 13. Further details of the suction head, input member and mechanical arm are shown in FIGS. 25 to 28.

The tray device 200 may also comprise a tray conveyor (not shown) of a configuration capable of transferring the tray 20 from the stack of trays 27, and/or vacuum pad, to the preferred location of the tray next to the transfer device 500 for receiving fruit 10.

The tray device 200 may also comprises a sensor (not shown), to determine how many trays and/or if more than one tray, are being picked up. The tray device 200 is configured to re-actuate the input member/lateral wings 202 if the sensor (and optionally any associated processor) has determined if more than one tray is being picked up. The sensor may be a light level detection sensor. The light level detection sensor in one embodiment is configured to work in combination with a light source. The sensor and/or processor is configured to measure the difference between ambient light and the light bounced off one tray, or more than one tray.

In one embodiment, the tray device 200 utilises a stream of gas to be blown onto the side of a stack of trays. The stream of gas aids in separating of adjacent trays from one another. The trays of a stack may be sometimes be compressed, sticky or have static between them. Gas, such as air, blowing onto the sides, and thus in between, the trays aid in separation of the trays.

The system 1000 preferably comprises a wrapper 600 which is an apparatus configured to wrap the tray 20 within a thin plastic film 602. Such film 602 is currently used in the kiwifruit industry for wrapping trays laden with fruit. The film is generally rectangular in shape. The film is generally composed of a lightweight HDPE plastic film.

The tray 20 will be described as having the following features, two opposing sides 21, a front 23 opposing an end 22—both at 90° to the sides 21, a top 24 where the fruit is laid, and a bottom 25, opposite the top 24.

The wrapper 600 generally comprises the following wrapping steps,
The film is located under the tray bottom 25, from the direction of the tray front 23.
The film is folded about the tray end 22, so that one end of the film is folded towards the opposite tray front 23.
The sides of the film are then folded about the tray sides 21, and under the tray bottom 25.

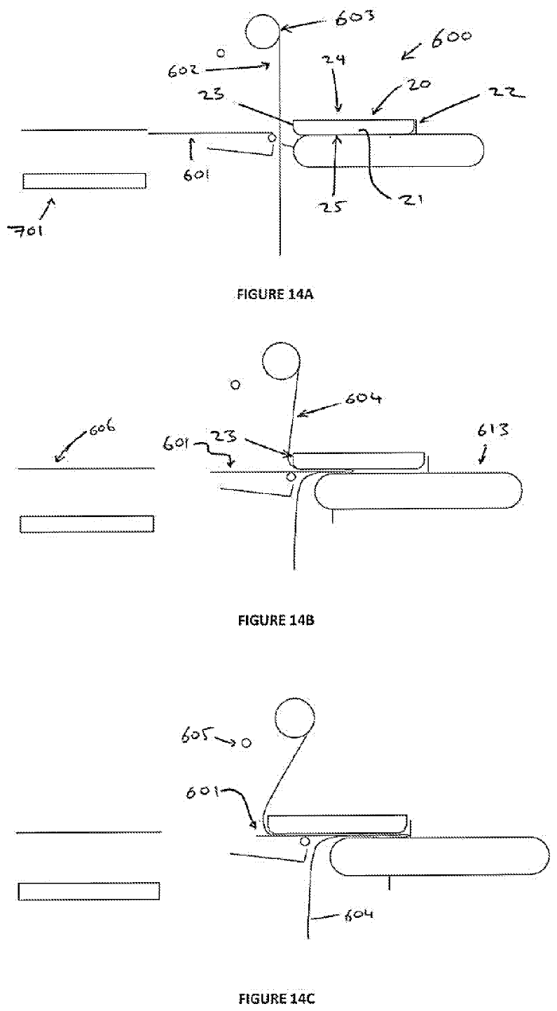

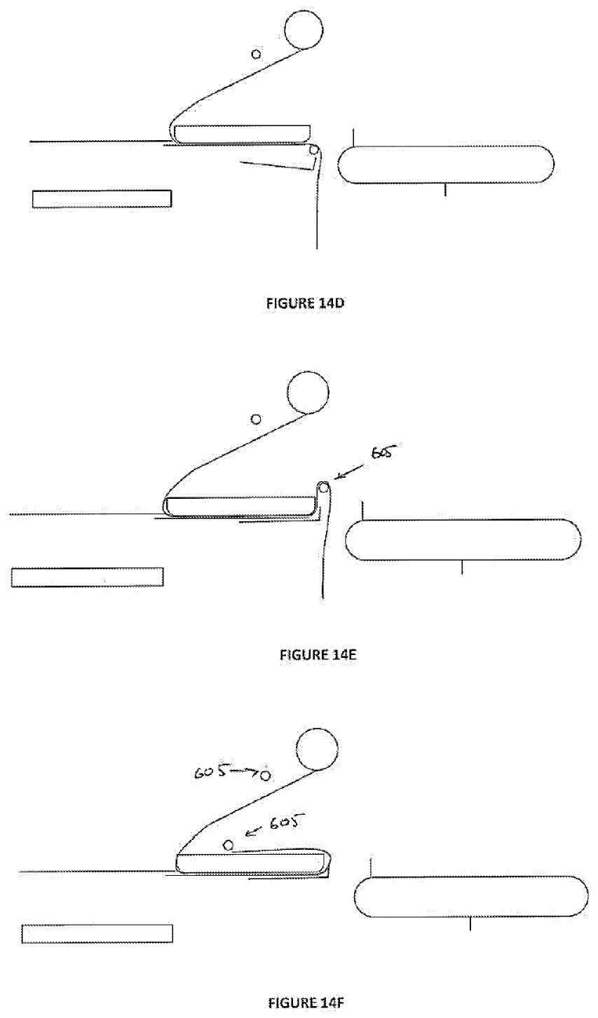

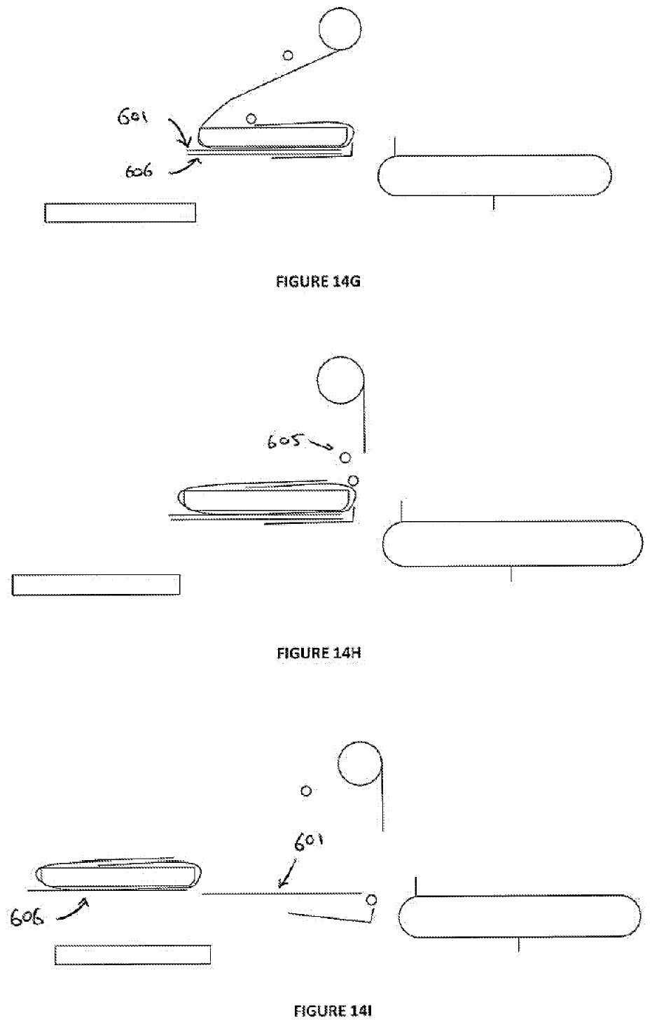

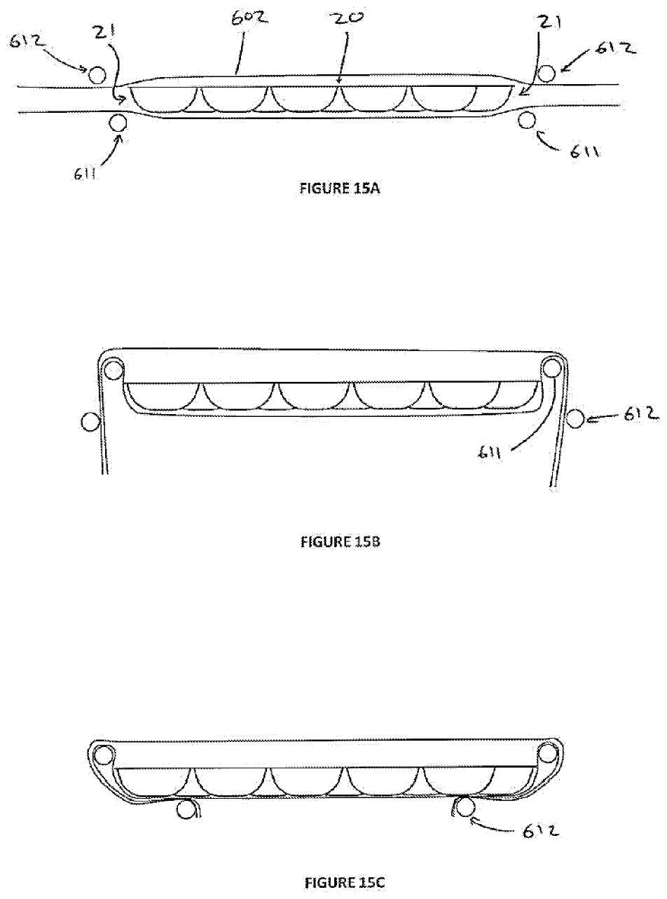

These steps will now be described in greater detail, and in accordance with the preferred embodiment as shown in the sequence of FIGS. 14 and 15.

The wrapper 600 comprises a tray carriage 613, which supports the tray 20 laden with fruit. This tray carriage 613 may be part of the other parts of the system 1000. For example, it may be the same tray carriage that transports the tray from the tray stack 27 to the location of the transfer device 500. Alternatively, the tray carriage may be a separate tray carriage that receives a tray laden fruit from the transfer device area.

Typically, a roll of film 603 is located above, and in front of, the tray carriage 613. A portion 604 of thin plastic film 602 is pulled down in front of the tray carriage 613 and said tray 20—as shown in FIG. 14 A.

In one embodiment, a hollow bar is used to pull down the plastic film 602 in front of the tray. This hollow bar 620 is shown in FIG. 28. The hollow bar 620 comprises one or more, or a series of holes 621 within the periphery of the bar 620. A vacuum 622 is drawn through the chamber 623 defined by the bar, to create a pressure differential through the holes 6221 When the plastic film 602 is near or at the holes 621, the plastic film 602 is drawn at least partially into, or covers, the holes 621. This allows the hollow 620 bar to have a grip on the plastic film 602. Once the hollow bar 620 has a grip, the hollow bar 620 is configured to rotate about it elongate axis to get a wrap of film about the bar's periphery, and hence get a better grip on the plastic film. Once a better grip has been achieved, the hollow bar is configured to be pulled down to pull the plastic off a roll of the same. Once pulled down, at some stage in the process the vacuum 622 can be released, and optionally the bar rotated in the opposite direction, to release the grip on the plastic film 602.

The tray carriage 613 is pushed through the drawn down film 602, onto a film driver 601—and/or the film driver 601 is driven intermediate the tray 20 and the tray carriage 613. FIGS. 14 B-C show the tray carriage 613 pushing a tray 20 through a portion of film 604 onto a film driver 601, where the film driver 601 comes to meet the tray carriage 613. are

The film driver 601 is driven from the other side of the film in relation to the tray. As such, when the film driver 601 is driven intermediate the tray 20 and trade carriage 613, it pushes the film 602 that is hanging in front of the tray, intermediate the tray bottom 25 and tray carriage 613.

In one embodiment, the film driver 601 is then reversed, now supporting the tray, with the film 602 intermediate, as shown in FIG. 14D. The tray 20 may be continued to be supported by the film driver 601 or may be transferred and another supporting tray 606. The advantage of using another supporting tray 606, independent from the film driver 601, is that the film driver 601 may be wider than the supporting tray 606.

The film 602 is folded over of the tray end 22 (by a bar/s 605 or other like feature) as shown in FIG. 14D-F. And likewise, the film 602 is folded over the tray front 23 (by a bar/s 605 or other like feature) as shown in FIGS. 14G-H. The film 602 is then torn/cut/split from the film roll 603 as shown in FIG. 14H.

FIG. 15A-C shows a cross-section schematic view of the process of folding the sides of the film about the tray sides 21 and under the tray bottom 25. After this step has occurred, the tray 20 is fully wrapped. The wrapper comprises a film tucker 610, to tuck the film 601 about the tray sides 21 and under the tray bottom 25. The film tucker 610 comprises two pairs of bars, a holding bar 611 and a tucking bar 612, located at each tray end 22 when a tray is present, the holding bars 611 are located under the wrapped tray when present, the tucking bars 612 are located above the wrapped tray when present; the tucking bars 612 configured to actuate downwards below the holding bars 611, and inwards towards each other under the tray bottom 25 to therefore wrap the film around the tray sides 21. The holding bars ensure that the plastic doesn't crush/deform the tray when the wrapping bars are pulling/tucking the film in.

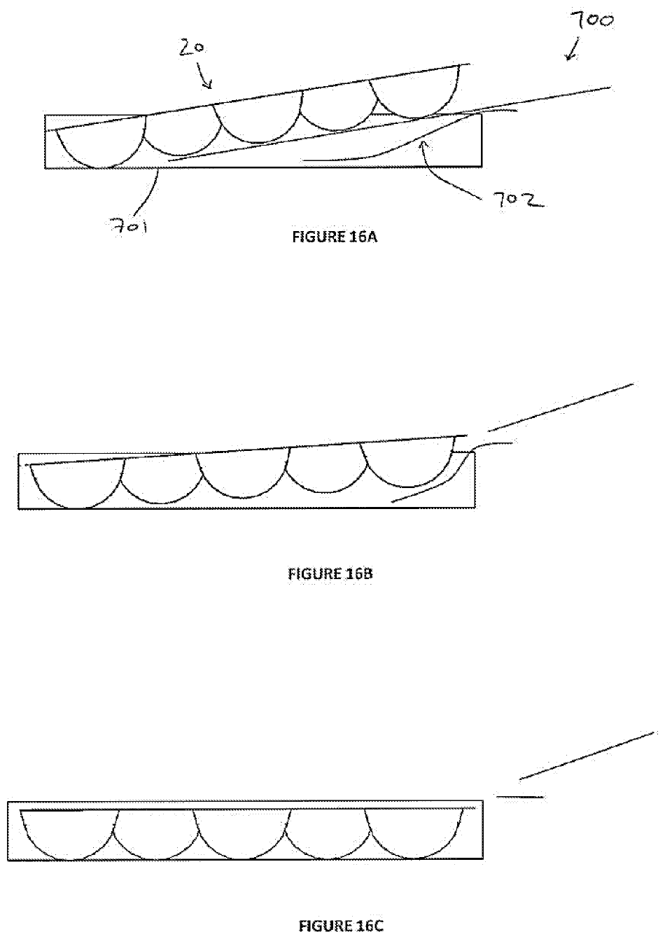

Once wrapped, a depositing apparatus 700 allows (the preferably wrapped) trays to be softly loaded into complementary shaped container 701, as shown in FIG. 16. The depositing apparatus 700 may be used in standalone or fitted to another mechanism which loads the tray into the container. Preferably the container is a cardboard carton.

This depositing apparatus comprises a tray support 703 (which in some embodiments may be comprised by the film driver 601), a flexible member 702 and a means (not shown) to actuate the both the tray support 601 and the flexible member 702 into and out of a container 701.

The flexible member 702 needs to be in the container 701 before the tray support 601 has loaded the tray 20 into the container 701. Once the tray 20 being loaded into the container 701 is no longer contacting the tray support 601, the flexible member 702 can be slid out, allowing the tray 20 to gently drop into the container 701. The flexible member 702 may be integral, attached or coupled to the supporting tray 606. The flexible member 702 would be retracted upon entering the container 701, and protruded out when there is room for it in the container 701 (for example as the tray support 606 is halfway in the container 701), then retracted after the supporting tray 606 has exited the container 701.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

Preferably the processes herein described are at least partially, or fully automated.

1. An apparatus for presenting generally spherical or prolate like items for off take, the apparatus comprising or including a conveyor, the conveyor comprising; a receiving zone receive said items, a downward sloped alignment zone to at least convey the items down the alignment zone towards an off take zone to allow or cause the off take of the items from the conveyor; wherein the items can advance under gravity in an advancement direction down the sloped alignment zone, from the receiving zone to the off take zone, whilst being supported on a rising support surface or rising support surfaces of the conveyor, that rise in direction up the sloped alignment zone, opposite to the direction of the advancement direction.

2. The apparatus as claimed in claim 1, wherein the receiving zone is able to receive prolate, ovoid or the like elongate items in heterogenous alignments to each other, and the alignment zone is configured to align the items to a homogenous alignment with their major axis transverse to the advancement direction, and the off take zone is configured to allow or cause the off take of the items still in said homogenous alignment.

3. The apparatus of claim 1 or 2, wherein at least part of the item support surface or surfaces of one, two or all three of the zones has item stream partition features whereby in use separated streams of items present for serial off take of the lowermost or most advanced item of each stream.

4. The apparatus as claimed in any one of claims 1 to 3, wherein the conveyor is a belt conveyor, roller, or a series of rollers.

5. The apparatus of claim 1, wherein the off take zone is adapted for placement of each item into a pocket of a tray.

6. The apparatus as claimed in any one of claims 1 to 5, wherein the receiving zone cascades items onto the alignment zone or itself has a rising surface or rising surfaces from which items can advance under gravity, where the rising surface is a belt, walking beam or other conveyor, drum roller, or the like, and the rising surfaces is a plurality of rollers, plural rollers but with static interposed supports, or the like.

7. The apparatus as claimed in any one of claims 1 to 6, wherein the apparatus comprises a plurality of elongate lanes parallel each other and extending in the advancement direction, the lanes configured to partition a stream or pool of items received at the receiving zone, into lanes of single file items at the alignment zone and/or off take zone.

8. The apparatus of claim 7, wherein the lane has an exit region at the off take zone, where items are configured to be retained, by a holder, within the lane, the items in lane constantly rotating about their major axes due to the rising support surface or rising support surfaces.

9. A method of guiding a spherical, prolate, ovoid or the like rollable item so that it may be fed into a plurality of elongate lanes on a declined slope, the lanes parallel each other and extending in an advancement direction, said method comprising the step of gravity advancing the item in a stream of such items against the rising movement of a surface on which the items are supported.

10. A method of aligning a prolate, ovoid or the like item so that it may be fed laterally of its major axis, said method comprising the step of gravity advancing the item in a stream of such items against the rising movement of a surface on which the items are supported.

11. The method of as claimed in claim 8 or 9, wherein the item is kiwifruit.

12. The method of as claimed in any one of claims 9 to 11, wherein the surface is of a conveyor.

13. The method of as claimed in claim 12, wherein the conveyor is a belt conveyor, roller, or a series of rollers.

14. The method of as claimed in claim 13, where there is the step of taking the fed items or receiving the fed items from the surface for placement in that alignment into a pocket of a fruit tray.

15. A method of presenting a side of an item to a first direction by rotating the item about two axes, the method comprising the steps of
a. rotating the item about a first axis to a first orientation, by at least two parallel rollers that support said item, the rollers rotating about roller axes parallel to the first axis,
b. separating the item in the first orientation from the two rollers by a transfer device,
c. rotating the item to a second orientation, by rotating the transfer device, about a second axis not parallel (preferably perpendicular) to the first axis, and
d. re-supporting the item on the two rollers in the second orientation.

16. The method as claimed in claim 15, wherein the method comprises the step of, when required to achieve presentation of the side of the item to a first direction, rotating the item about the first axis to a third orientation by the rotation of the rollers, after step d.

17. The method as claimed in claim 15, wherein the method comprises the step of removing the item from the rollers by one or more selected from a transfer device, and actuating the rollers so the item falls off the rollers.

18. The method as claimed in claim 16, wherein the method comprises the step of the item being received by a second set of parallel rollers that are configured to one or both of a) actuate to cause the item to fall off the rollers and b) rotate the item about a horizontal axis to a third orientation by the rotation of the second set of rollers.

19. The method as claimed in any one of claims 15 to 18, wherein one or more of the rollers are rotatably driven.

20. The method as claimed in any one of claims 15 to 19, wherein the separating of the item from the rollers is achieved by lifting the item from the rollers, and/or the re-supporting of the item on the rollers is achieved by placing the item onto the rollers.

21. The method as claimed in claim 20, wherein the direction of movement of lifting the item off the two rollers and/or placing the item onto the two rollers, is collinear with the second axis.

22. The method as claimed in any one of claims 15 to 21, wherein the method includes the step of providing optical means to determine in what orientation the item is in, and/or should be in.

23. The method as claimed in any one of claims 15 to 22, wherein the method includes the step of determining an optimum side of the item.

24. The method as claimed in claim 23, wherein the method includes the step of orientating the item so that a side, and/or the optimum side is orientated in a first direction.

25. The method as claimed in claim 24, wherein the first direction is upwards.

26. The method as claimed in any one of claims 15 to 25, wherein the method includes the step of transferring the item from the rollers, into a tray, by the transfer device, with the side presenting in the first direction.

27. The method as claimed in any one of claims 15 to 26, wherein the item is spherical, prolate, ovoid, and/or of a rollable, shaped item, and/or the item is a fruit.

28. The method as claimed in any one of claims 15 to 27, wherein the rollers can support multiple items laterally adjacent each other.

29. The method as claim in claim 28, wherein there are multiple transfer devices to complement the multiple items.

30. The method as claimed in any one of claims 15 to 29, wherein there are multiple transfer devices for relating to one item, each transfer device with a different function.

31. The method as claimed in claim 30, wherein the apparatus comprises one or more transfer devices configured for one or more of the following:
a. transfer the item from the conveyor onto the first set of rollers
b. separate the item from the first set off rollers and/or second set of rollers
c. rotate the item when separated from first set off rollers and/or second set of rollers
d. transfer the item to the second set of rollers
e. transfer the item from the first set off rollers and/or second set of rollers to a carton or other location.

32. The method as claimed in any one of claims 15 to 31, wherein the transfer device is or comprises one of a suction cup or a gripping mechanism.

33. An apparatus for presenting a side of an item to a first direction, the apparatus comprising
a. at least a pair of rollers, of which at least one is rotationally driven, having parallel rotational axes, configured to support and rotate the item about a first axis parallel with the roller rotational axes,
b. one or more transfer devices configured to,
i. removable couple to the item;
ii. once coupled, separate and re-support the item from and to the rollers; and
rotate about a second axis not parallel (preferably perpendicular) to the first axis, so in operation said coupled item can be rotated respectively when separated from the rollers.

34. The apparatus as claimed in claim 33, wherein the apparatus comprises a second set of parallel rollers that are configured receive an item and also configured to one or both of a) actuate to cause the item to fall off the second set of rollers and b) rotate the item about a horizontal axis to a third orientation by the rotation of the second set of rollers.

35. The apparatus as claimed in claim 34, wherein one or more of the rollers of the second set of rollers are rotatably driven.

36. The apparatus as claimed in any one of claims 34 to 35, wherein the first and second set of rollers can support multiple items laterally adjacent each other.

37. The apparatus as claimed in any one of claims 34 to 36, wherein there are one or more transfer devices configured to one or more of the following:
a. transfer the item from the conveyor onto the first set of rollers
b. separate the item from the first set off rollers and/or second set of rollers
c. rotate the item when separated from first set off rollers and/or second set of rollers
d. transfer the item to the second set of rollers
e. transfer the item from the first set off rollers and/or second set of rollers to another location.

38. The apparatus as claimed in any one of claims 34 to 35, wherein the transfer device is or comprises one of a suction cup and a gripping mechanism.

39. An apparatus for laterally retaining generally spherical or prolate like items, the apparatus comprising
a. a conveyor to convey items to an off take zone,
b. a holder to receive items from or partially from the off take zone, the holder and conveyor together, or the holder alone, configured to move the item to and/or support the item at, a transfer region,
c. at least one holder divider located at the transfer region, the holder dividers configured to retain the item laterally with respect to the elongate member.

40. The apparatus as claimed in claim 39 wherein the holder divider is vee shaped.

41. The apparatus as claimed in claim 40 wherein vee shaped holder divider has flexible lateral walls that form the vee shape.

42. The apparatus as claimed in any one of claims 39 to 41, wherein the holder comprises one or more holding members that are elongate cylinders, and/or wherein one or more of the holding members are configured to rotate about their elongate axis.

43. The apparatus as claimed in any one of claims 39 to 42, wherein the vee shaped holder divider is located intermediate the conveyor and holder, and/or at the vee shaped holder divider is located at the transfer region.

44. The apparatus as claimed in any one of claims 39 to 42, wherein the vee shaped holder divider is located intermediate the two holding members that comprise the holder

45. The apparatus as claimed in any one of claims 39 to 44, wherein the vee shaped holder divider is configured to orientate items about their elongate axis, if present, to be parallel the elongate axis of the holding member(s).

46. A method of laterally retaining generally spherical or prolate like items, the method comprising the steps of
a. providing the apparatus of claim 39,
b. receiving an item on the conveyor,
c. conveying the item to an off take zone via the conveyor,
d. receiving the item at a transfer region from the off take zone, where the item is at least partially supported by the holder, and
e. retaining the item with the at least one holder divider at the transfer region laterally relative to the holder

47. The method as claimed in claim 46, wherein the holder comprises one or more holding members that are elongate cylinders.

48. The method as claimed in claim 46 or 47, where the holder divider is vee shaped.

49. The method as claimed in claim 48, wherein the holder divider has flexible lateral walls that form the vee shape.

50. The method as claimed in any one of claims 46 to 49, wherein the step of rotating one or more selected from; the holding member, the holding members, and the conveyor, whilst the item is supported at least partially by the holder and retained by the holding member.

51. The method as claimed in any one of claims 46 to 50, wherein the holding member is vee shaped and has lateral walls in contact with the item so the item tends to orientate its elongate axis to be parallel the elongate axis of the holding member, when the item is also rotated via one or more selected from the holding member, the holding members, and the conveyor.

52. As claimed as claimed in any one of claims 46 to 51, wherein the method comprises the step of presenting the item for transfer from the transfer region.
